(19) United States
(12) Patent Application Publication
(10) Pub. No.: US 2014/0045670 A1
(43) Pub. Date: Feb. 13, 2014

(54) CENTRIFUGE APPARATUS, CENTRIFUGE TUBES, AND METHODS FOR AUTOMATED CELL PREPARATION

(71) Applicants: Thomas L. Smith, Campbell, CA (US); Bryan Wade, Redwood City, CA (US); Edward Verdonk, San Jose, CA (US)

(72) Inventors: Thomas L. Smith, Campbell, CA (US); Bryan Wade, Redwood City, CA (US); Edward Verdonk, San Jose, CA (US)

(73) Assignee: MOLECULAR DEVICES, LLC, Sunnyvale, CA (US)

(21) Appl. No.: 13/569,119

(22) Filed: Aug. 7, 2012

(51) Int. Cl. B04B 5/02; B01L 3/00; B01D 43/00

(52) U.S. Cl. 494/20; 494/16; 494/37; 422/548

(57) ABSTRACT

An automated centrifuge apparatus for conducting a cell preparation procedure is provided. A rotor assembly supports centrifuge tubes, which are installable at respective tube positions. The tube positions are indexable to an index location. A sensing module monitors the index location during a set of status checks, which relate to the centrifuge tubes. Logic signals generated by the sensing module are used to automatically determine whether the status checks are satisfied.

### RELATED APPLICATIONS

This application is related to utility patent applications titled APPARATUS AND METHOD FOR SEPARATING MATERIALS OF DIFFERENT DENSITIES and APPARATUSES AND METHODS FOR CONDITIONING AND REORIENTING COMPONENTS OF AN ELECTROPHYSIOLOGY MEASUREMENT SYSTEM both filed on Aug. 7, 2012.

### TECHNICAL FIELD

This invention relates to electrophysiology and systems and apparatus utilized to carry out electrophysiology-related measurements and assays, particularly in an automated and semi-automated manner. More specifically, the invention relates to apparatuses and methods for preparing cell solutions used in such systems.

### BACKGROUND

The electrical behavior of cells and cell membranes is of profound importance in basic research as well as in modern drug development. A specific area of interest in this field is in the study of ion channels and transporters. Ion channels are protein-based pores found in the cell membrane that are responsible for maintaining the electrochemical gradients between the extracellular environment and the cell cytoplasm. Ion channels are passive elements in that, once opened, ions flow in the direction of existing electrochemical gradients.

The study of ion channels is a very diverse and prolific area encompassing basic academic research as well as biotechnical and pharmaceutical research. Electrophysiology is performed on isolated cell membranes or vesicles as well as on synthetic membranes where solubilized channels are reconstituted into a manufactured membrane. Instrumentation for automated, high-throughput studies of ion channels have been developed and may be referred to as high-throughput electrophysiological measurement systems.

While automated high-throughput measurement systems may be employed to perform electrophysiological assays in a relatively quick and efficient manner, such systems may not be equipped to automatically prepare the cells and cell solutions used in the assays. Therefore, a need exists for systems and methods to automatically prepare the cells and cell solutions used in electrophysiology assays.

### SUMMARY

An automated method for monitoring an automated centrifuge apparatus during a cell preparation procedure is provided. A set of status checks are conducted during a cell preparation procedure. The status checks relate to centrifuge tubes installed at a rotor assembly of the apparatus. A sensing module monitors an index location at the apparatus during the cell preparation procedure. It is then determined whether individual status checks are satisfied based on the status of the centrifuge tubes, which are positionable at the index location. In response to a determination that at least one of the status checks is not satisfied, a fault condition is indicated.

An automated centrifuge apparatus for conducting a cell preparation procedure is also provided. A rotor assembly supports centrifuge tubes, which are installable at respective tube positions. The tube positions are indexable to an index location. A sensing module monitors the index location during a set of status checks, which relate to the centrifuge tubes. Logic signals generated by the sensing module are used to automatically determine whether the status checks are satisfied.

A centrifuge tube for use in an automated centrifuge apparatus during a cell preparation procedure is further provided. The centrifuge tube includes a cylindrical upper portion, a conical lower portion adjoining the cylindrical upper portion, and an interior pocket formed at the conical lower portion. The interior pocket collects cells during cell pelletization such that the cells are positioned away from a pipettor when the pipettor is inserted into the centrifuge tube.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout different views.

FIG. 1 is a top view of an example of an implementation of an automated high-throughput electrophysiology measurement system.

FIG. 2 is a side view of an example of an implementation of a robotic pipettor head of an automated high-throughput electrophysiology measurement system.

FIG. 3 is a side cross-sectional view of an example implementation of a patch plate supported on a plenum of an automated high-throughput electrophysiology measurement system.

FIG. 4 is a flowchart of example method steps of a cell preparation procedure.

FIG. 5 is a top perspective view of an example of an implementation of an automated centrifuge apparatus.

FIG. 6 is a side view of the automated centrifuge apparatus of FIG. 5.

FIG. 7 is a flowchart of example method steps of a cell preparation procedure that includes tube status check procedures.

FIG. 8 is a flowchart of example method steps of a tube presence check procedure.

FIG. 9A is a top view of an example of an implementation of an automated centrifuge apparatus during a tube presence check procedure.

FIG. 9B is a side view of the automated centrifuge apparatus of FIG. 9A.

FIG. 10 is a flowchart of example method steps of a tube balance check procedure.

FIG. 11 is a flowchart of example method steps of a tube fill level check procedure.

FIG. 12A is a top view of an example of an implementation of an automated centrifuge apparatus during a tube fill level check procedure.

FIG. 12B is a side view of the automated centrifuge apparatus of FIG. 12A.

FIG. 13 is a flowchart of example method steps for a tube return to vertical check procedure.

FIG. 14A is a top view of an example of an implementation of an automated centrifuge apparatus during a tube return to vertical check procedure.

FIG. 14B is a side view of the automated centrifuge apparatus of FIG. 14A.

FIG. 15A is a top perspective view of an example of an implementation of a rotor assembly.

FIG. 15B is another top perspective view of the rotor assembly of FIG. 15A.

FIG. 16 is a front cross-sectional view of an example of an implementation of a pocketed centrifuge tube.

FIG. 17 is a close-up front cross-sectional view of a portion of the centrifuge tube of FIG. 16.

FIG. 18 is a top perspective cross-sectional view of a pocket of an example of an implementation of a pocketed centrifuge tube.

### DETAILED DESCRIPTION

Apparatuses, devices, and methods for the automated preparation of cells and cell solutions for use in an automated, high-throughput electrophysiology measurement system are provided. An automated centrifuge apparatus prepares cell concentrations during an automated cell preparation procedure. The automated centrifuge apparatus may be a component of an automated high-throughput electrophysiology measurement system thereby enabling automated on-deck preparation of cell concentrations for assays carried out by the system.

The automated centrifuge apparatus may include a sensing module utilized to execute status checks relating to the centrifuge tubes used in the preparation of the cell concentrations. The sensing module may be utilized during the cell preparation procedure to automatically determine the presence or absence of tubes, the fill status of the tubes, and the relative vertical orientation of the tubes.

Pocketed centrifuge tubes may be utilized during the cell preparation procedure in order to minimize damaging or degrading the cells as media is aspirated from and dispensed into the tubes. The automated centrifuge apparatus may also constrain the pivot angle of the tubes during the cell preparation process in order to minimize the footprint of the apparatus at the process deck of the system. These and other aspects relating to the automated centrifuge apparatus will be discussed in further detail below.

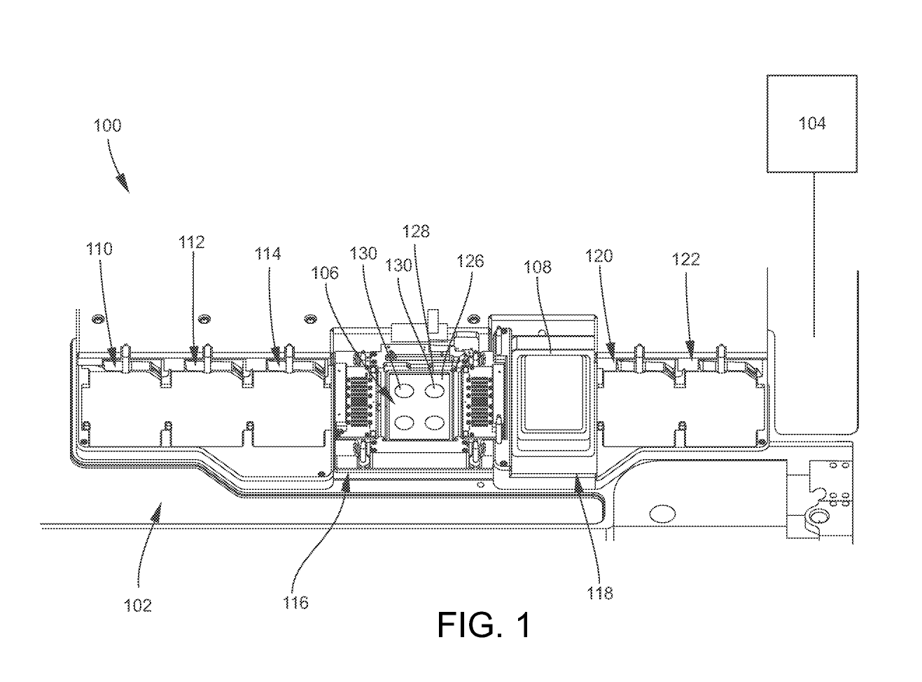

Referring to FIG. 1, an example of an implementation of an automated high-throughput electrophysiological measurement system 100 is shown in a top view. The system 100, in this example, is configured to conduct simultaneous measurements on multiple samples (e.g., a two-dimensional grid or array of samples). The high-throughput electrophysiological measurement system 100 may include a measurement platform 102, which may also be referred to as a process deck 102. The process deck 102 may support the various components of the system 100 and may comprise a generally planar surface for supporting or maintaining a desired spatial arrangement of some or all of the components of the measurement system 100.

The system may include a control module 104 that controls operation of the system 100 during an assay. The control module 104 may include, for example, an external microcomputer, display device, and software user interface. The control module 104 may also include a microcontroller interfaced to the external microcomputer for controlling the real-time functional aspects of the system 100 including motion control, fluidics control, and electrical data recording.

The system 100 may also include a patch engine that controls the components of the system 100, performs electrophysiological measurements, and digitizes the data acquired during patch clamp assays. The patch engine, in this example, includes a plenum 106, electrode plate 108, and data acquisition engine. These components will be discussed in further detail below.

The system 100 may include multiple stations or modules configured for implementing various functions. In the illustrated example, the system 100 includes seven stations: a tip rack station 110; an external buffer station 112; a first compound station 114; an analysis station 116; a wash station 118; a second compound station 120; and a cell station 122. It will be understood that the system 100 may include more or less stations, including stations providing functions different from those just noted.

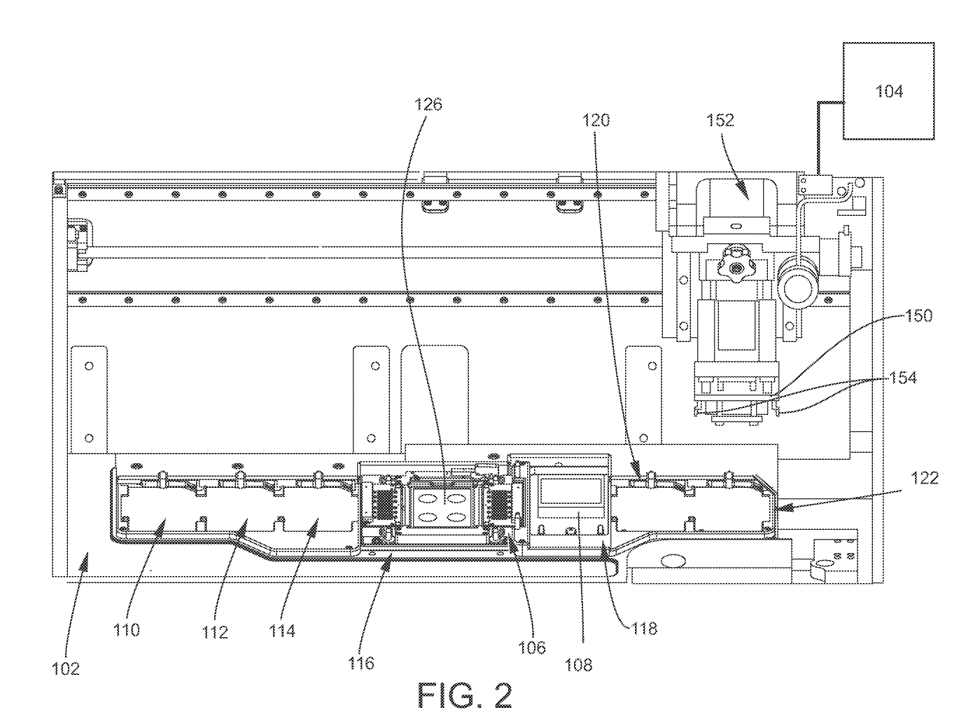

Each of the stations, in this example, is shaped to receive an SBS-standard 384-well microtitre plate (Society for Biomolecular Sciences). In other words, the stations, in this example, may be described as having an SBS-standard 384-well microplate footprint. Assay steps take place at the process deck 102, and a robotic pipettor head delivers fluids from the external buffer station 112, cell station 122, and compound stations 114 and 120 to a measurement substrate at the analysis station 116. The robotic pipettor head will be discussed further below with reference to FIG. 2.

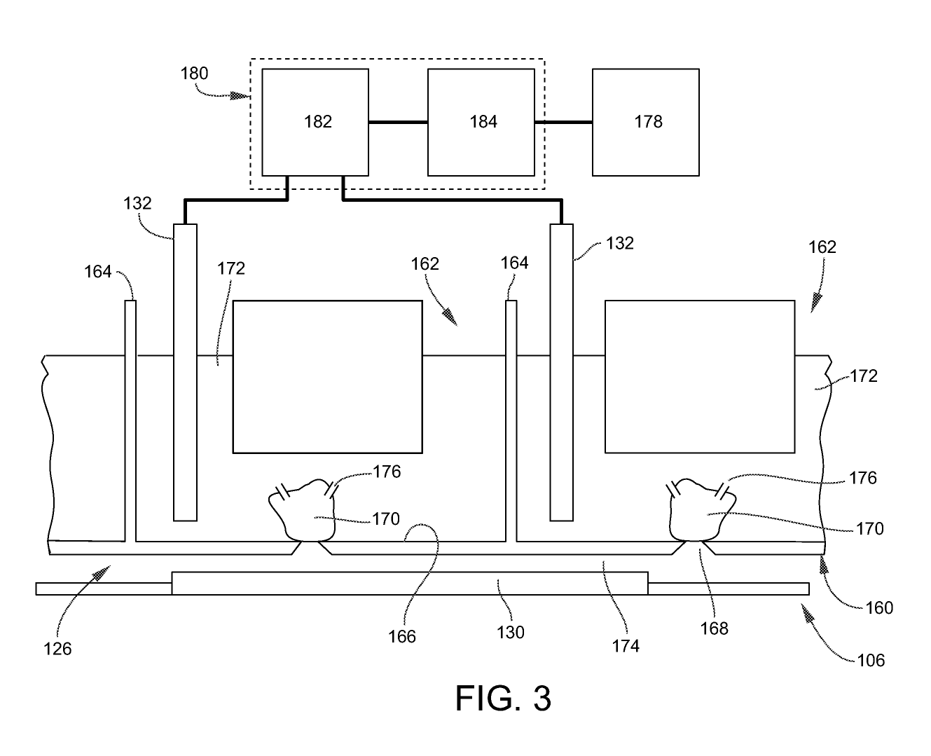

The measurement substrate may be referred to as the patch plate and may include multiple holes or apertures around which corresponding samples (e.g., cells or cell membranes) may be positioned or sealed for analysis. The patch plate, in this example, is an SBS-standard 384-well microplate. Accordingly, the patch plate, in this example, includes 384 individual wells for holding cells, external buffer solution, and biological screening compounds. The 384 wells of the patch plate, in this example, may be arranged in a grid of 16 rows (identified as A-P) and 24 columns (identified as 1-24). The wells of the patch plate may include one or more apertures formed through the lower surface. Each aperture may have a diameter of, for example, about 2 micrometers (μm). A patch plate having one aperture per well may be referred to as a single-hole plate. A patch plate having multiple apertures per well (e.g., an array of 64 apertures) may be referred to as a population patch clamp (PPC) plate. The patch plate may be moved to and from the analysis station during an assay. The patch plate will be discussed further below with reference to FIG. 3.

The tip rack station 110 holds a tray that may be preloaded with pipettor tips. The robotic pipettor head may lower onto the tip rack station 110 to load the pipettor tips at the start of an assay. The pipettor tips may be utilized to aspirate and dispense external buffer solution, compounds, and cells at appropriate times during a given assay, depending on the particular method specified for the assay.

The external buffer station 112 may also be referred to as an input station and may include an external buffer boat that holds external buffer solution. In some example implementations, a peristaltic pump and vacuum-assisted waste bottle may be selectively employed to automatically fill and drain the external buffer station 112. The external buffer boat may be filled with external buffer solution prior to the start of an assay. The external buffer solution may be a physiological saline solution comprising a salt or mixture of salts that mimics extracellular solution (e.g., a solution containing low concentrations of potassium). The robotic pipettor head may aspirate the external buffer solution from the external buffer station 112, transport the external buffer solution to the analysis station 116, and dispense the buffer solution into the wells of the patch plate.

The first and second compound stations 114 and 120 may also be referred to as input stations and hold biological screening compounds or other types of reagents that may be utilized during the assay. An SBS-standard 384-well compound plate (e.g., a microplate) may hold the biological screening compounds and reside within the footprint at the first or second compound station 114 or 120. The robotic pipettor head may similarly aspirate the compounds from the compound stations 114 and 120, transport the compounds to the analysis station 116, and dispense the compounds into the wells of the patch plate.

The analysis station 116 includes the plenum 106 of the patch engine and supports the patch plate during the assay. The plenum 106 includes a reservoir 126, and an internal buffer solution may be pumped into and out of the plenum reservoir 126 from below during an assay. The internal buffer solution may be a saline solution comprising a salt or mixture of salts that mimics the internal cytoplasm of a living cell (e.g., a solution containing high concentrations of potassium). The patch plate rests on the plenum 106, and an o-ring 128 surrounding the perimeter of the plenum 106 creates an air-tight seal between the patch plate and the plenum reservoir 126. A small negative (differential) pressure is introduced that pulls cells (or cell membranes) residing in the wells toward the aperture at the bottom of the well. The differential pressure thus forms a high-resistance electrical seal between the cell (or cell membrane) and the bottom of the well, as appreciated by persons skilled in the art.

The electrode plate 108 may be referred to as an electronics head and used to perform electrophysiological measurements on cell samples at the patch plate. Electrophysiological measurements may be performed by forming an electrical circuit across the apertures in the wells of the patch plate. An electrical circuit may be formed by positioning electrodes on opposite sides of the membrane of the patch plate. For example, a sense electrode may be positioned above the membrane, and a ground electrode may be positioned below the membrane. Accordingly, the plenum 106, in this example, includes four ground electrodes 130 positioned at the top of the plenum reservoir 126, and the electrode plate 108, in this example, may include an array of sense electrodes 132 housed in a frame that fits on top of the patch plate and plenum. The electrode plate 108 will be discussed in further detail below with reference to FIG. 2 and FIG. 3.

The arrangement of the sense electrodes 132 of the electrode plate 108 may correspond to the arrangement of the wells of the patch plate such that each sense electrode 132 may perform an electrophysiological measurement at a respective well of the patch plate. Accordingly, the electrode plate 108, in this example, may include an array of 384 sense electrodes 132. Each sense electrode 132 may correspond to an electronic channel. Accordingly, the 384 sense electrodes 132 in this example correspond to 384 electronic channels.

The electrodes 132 may be, for example, silver or silver-coated pins (i.e., Ag/AgCl). To complete the circuit, a suitable electrolyte (e.g., saline) solution may be added to the wells of the patch plate and the plenum reservoir 126. For example, the external buffer solution and the internal buffer solution may contain chloride ions to enable the sense electrodes 132 and ground electrodes 130 to monitor electrical activity.

The electrode plate 108 may be clamped to the plenum 106 during an assay such that the sense electrodes 132 are received into respective wells of the patch plate. The electrode plate 108 may include apertures formed through its upper surface to provide access to the pipettor tips. In this way, the electrode plate 108 allows for the addition of compounds to the patch plate wells while simultaneously measuring ion current in the wells. As discussed further below with reference to FIG. 3, the sense electrodes 132 and the ground electrodes 130 may be coupled to measurement electronics to obtain data relating to the electrophysiological measurements.

The wash station 118 may receive various components in order to clean those components following an assay. The wash station 118, in this example, includes a reservoir that accommodates the pipettor tips and the electrode pins of the electrode plates for the washing procedures. Accordingly, the wash station 118, in this example, may include a manifold of input ports that match the dimensionality of the pipettor tips and electrode pins. A fluid handling system (not shown) may pump cleaning solution through the wash station 118, which may then empty into waste carboys (not shown) below the process deck 102. The wash station 118 may also serve as a resting position for the electrode plate when not in use. The robotic pipettor head may pick up the electrode plate 108 at the wash station 118 and transport the electrode plate 108 to the analysis station 116 during an assay. The robotic pipettor head may then return the electrode plate 108 to its resting position at the wash station 118 at the conclusion of an assay.

The cell station 122 may also be referred to as an input station and include a cell boat that holds the cells (or other biological samples) used in an assay. The cells may be suspended in an external buffer solution while residing in the cell boat. The robotic pipettor head may similarly aspirate the cells from the cell station 122, transport the cells to the analysis station 116, and dispense the cells into the wells of the patch plate.

Referring now to FIG. 2, an example of an implementation of a robotic pipettor head 150 for a high-throughput electrophysiology measurement system 100 is shown in a side view. The robotic pipettor head 150 may also be referred to as a fluidics head or a multi-channel dispensing head. The robotic pipettor head 150 may be used to add, remove, replace, or transfer fluids, cell solutions, and compounds into the wells of a patch plate. The robotic pipettor head 150, in this example, may hold the pipettor tips utilized to transport fluids from the cell station 122, the external buffer station 112, and the compound stations 114 and 120 to the analysis station 116. The pipettor tips aspirate or dispense the fluids in precise amounts according to the assay protocols.

The robotic pipettor head 150 may be coupled to a three-dimensional mechanical gantry system 152 for moving the robotic pipettor head 150 between the stations of the process deck. The control module 104 may communicate with the mechanical gantry system 152 to control the movement of the robotic pipettor head 150 during an assay.

At the start of an assay, the robotic pipettor head 150 may move to the tip rack station 110 and load the pipettor tips. The robotic pipettor head 150 may also serve as the transport mechanism for the electrode plate 108. Accordingly, the robotic pipettor head 150 may, for example, include electrode plate transport clips 154 that hold the electrode plate 108. The robotic pipettor head 150 may load the electrode plate 108 from its resting position at the wash station 118 and transport it to the analysis station 116 where it clamps to the plenum 106 during the assay. At the conclusion of the assay, the robotic pipettor head 150 may load the electrode plate 108 from the analysis station 116 and transport it back to the wash station 118.

Referring now to FIG. 3, an example implementation of a patch plate 160 supported by a plenum 106 of a high-throughput electrophysiology measurement system 100 is shown. The patch plate 160 may include multiple wells 162 as discussed above (e.g., 384 wells). Two wells 162 of the patch plate 160 are shown by way of example in FIG. 3. Each well 162 is partitioned by a well wall 164 and bounded by the bottom 166 of the patch plate 160. Additionally, the wells 162 in the example patch plate 160 of FIG. 3 each include an aperture 168 formed through the bottom 166 of the patch plate 160. Cells 170 in the respective wells 162 may be sealed to the bottom 166 of the patch plate 160 via differential pressure as discussed above.

The wells 162 of the patch plate 160 may be filled with external buffer solution 172, and the plenum reservoir 126 of the plenum 106 situated beneath the patch plate 160 may be filled with internal buffer solution 174. Sense electrodes 132 may be positioned in the respective wells 162 of the patch plate 160 to measure the electrical activity occurring in the wells 162 during the assay, such as the activity of ion channels 176 of the cells 170 as appreciated by persons skilled in the art. The ground electrodes 130 of the plenum 106 may complete the electrical circuits across the respective apertures 138 of the patch plate 160.

The sense electrodes 132 of the electrode plate 108 and the ground electrodes 130 may communicate with the data acquisition engine 178 via measurement electronics 180 such as, for example, a programmable voltage source (not shown), an amplifier 182 and analog-to-digital converter (ADC) 184. As seen in the example shown in FIG. 3, the sense electrodes 132 and the ground electrodes 130 are in signal communication with the amplifier 182, which is in signal communication with the ADC 184, which is in turn in signal communication with the data acquisition engine 178. The amplifier 182 may be a high-gain, low-noise trans-impedance amplifier that converts the current measured on the sense electrode 132 to an analog voltage signal. The ADC 184 may convert the analog voltage signal from the amplifier 182 into a digital voltage measurement. The data acquisition engine 178 may thus save the digital voltage measurements for the sense electrode channels in a computer memory.

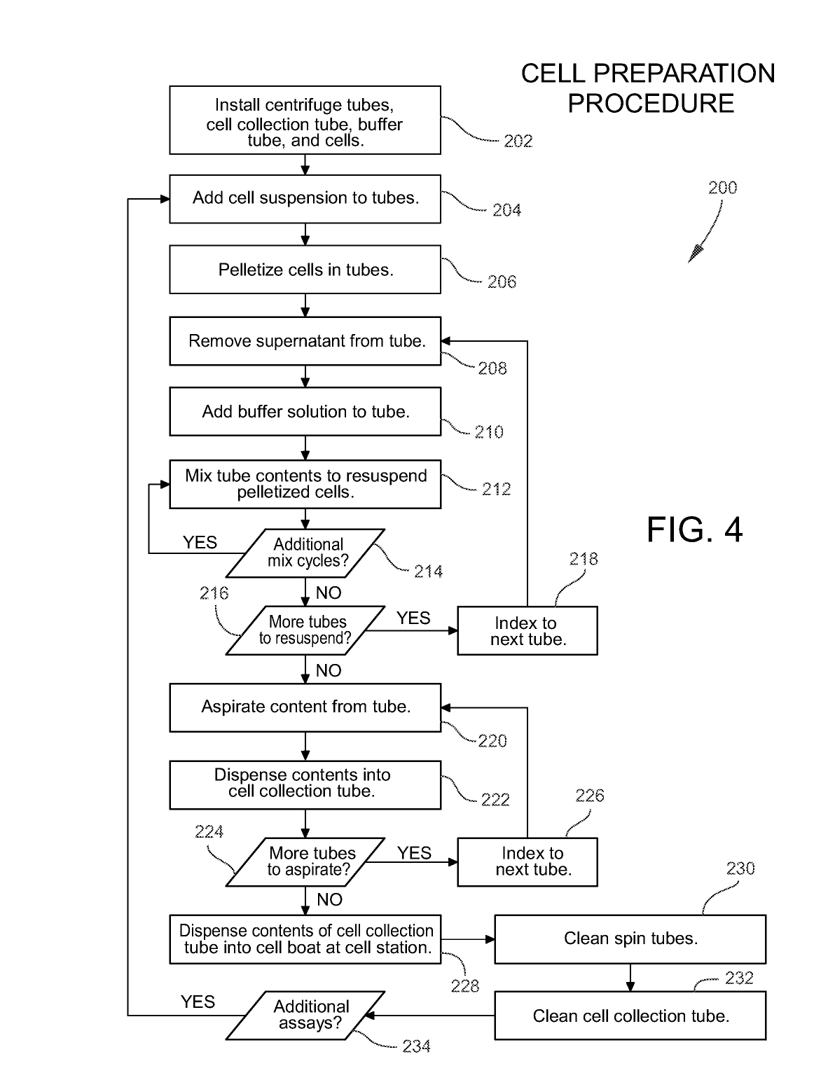

Referring to FIG. 4, a flowchart 200 of example steps of a cell preparation procedure are shown. To prepare cells for use in assays carried out by an automated high-throughput measurement system, an operator may set up a cell handling unit by installing centrifuge tubes, a cell collection tube, a buffer tube, and a starting mixture at the cell handling unit (step 202). The starting mixture may be, for example, a cell suspension that includes cells suspended in media (e.g., serum, buffer solution, antibiotics, etc.) The operator may load a relatively low-density cell supply into a cell cabana at the cell handling unit.

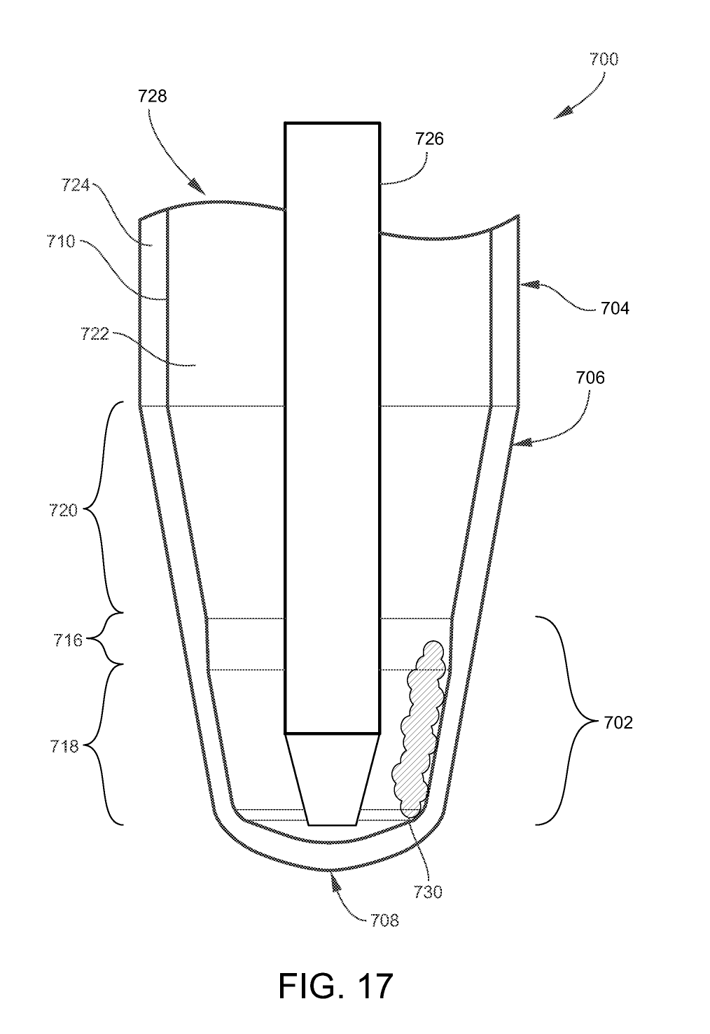

The cell handling unit may include a cell pipettor (FIG. 17). The cell pipettor is a robotic pipetting unit that may be positioned above the process deck and near the cell station. The cell pipettor delivers an ending mixture to the cell boat of the cell station for use during an assay. The ending mixture may be, for example, an ending cell suspension.

Once the centrifuge tubes are installed, the cell pipettor adds the relatively low-density cell supply from the cell cabana to the tubes (step 204). The cell handling unit then pelletizes the cells (step 206). After cell pelletization, the cell pipettor removes the supernatant (e.g., media, cell debris, etc.) from the tube (step 208) and adds a buffer solution to the tube (step 210). The cell handling unit then mixes the contents of the tube to resuspend the pelletized cells in the buffer solution, i.e., triturates the pelletized cells (step 212) to obtain a relatively high density cell solution. The cell handling unit may perform multiple mix cycles to resuspend the pelletized cells in the buffer solution. Accordingly, if additional mix cycles should be performed (step 214), then the cell handling unit may repeat step 212 to further mix the contents of the tube.

Additionally, the cell handling unit may prepare cell suspensions in multiple tubes. Accordingly, if additional tubes remain for resuspension of the tube contents (step 216), then the cell handling unit may index to the next tube (step 218) and repeat steps 208-214 in order to remove the supernatant from the next tube, add the buffer solution, and resuspend the pelletized cells in buffer solution.

If no more tubes remain for resuspension of the tube contents (step 216), then the cell pipettor may aspirate the relatively high-density cell solution from a tube (step 220) and dispense the cell solution into the cell collection tube (step 222). If additional tubes remain for aspiration (step 224), then the cell handling unit may index to the next tube (step 226) and repeat steps 220-224 to transfer the relatively high-density cell solution from the tubes to the cell collection tube.

If no more tubes remain to be aspirated (step 224), then the cell handling unit may dispense the contents of the cell collection tube into the cell boat of the cell station at the process deck (step 228). Once the cell handling unit dispenses the contents of the cell collection tube into the cell boat, the cell handling unit may clean the centrifuge tubes (step 230) by repeatedly rinsing the tubes with buffer solution. To rinse the tubes with buffer solution, the cell handling unit may infuse the tubes with the buffer solution and aspirate the buffer solution from the tubes. The cell handling unit may dispense aspirated buffer solution into a waste “spit” sink in between rinse cycles. The cell handling unit may also clean the cell collection tube (step 232) in a similar fashion by repeatedly rinsing the cell collection tube with buffer solution. Like the centrifuge tubes, the cell handling unit may repeatedly infuse the cell collection tube with buffer solution, aspirate the buffer solution from the cell collection tube, and dispense the aspirated buffer solution into a spit sink.

In this way, the cell handling unit may prepare cells for multiple assays to be performed by the automated high-throughput measurement system. If additional assays remain to prepare cells for (step 234), then the cell handling unit may repeat steps 204-232 in order to prepare cells for the additional assays.

As mentioned above, the cell preparation procedure may be automated. An automated cell preparation procedure may fail, however, if the cell handling unit is not set up properly. Missing or misaligned centrifuge tubes, an unbalanced centrifuge, or an insufficient amount of cell suspension can jeopardize the successful completion of the cell preparation procedure or an assay.

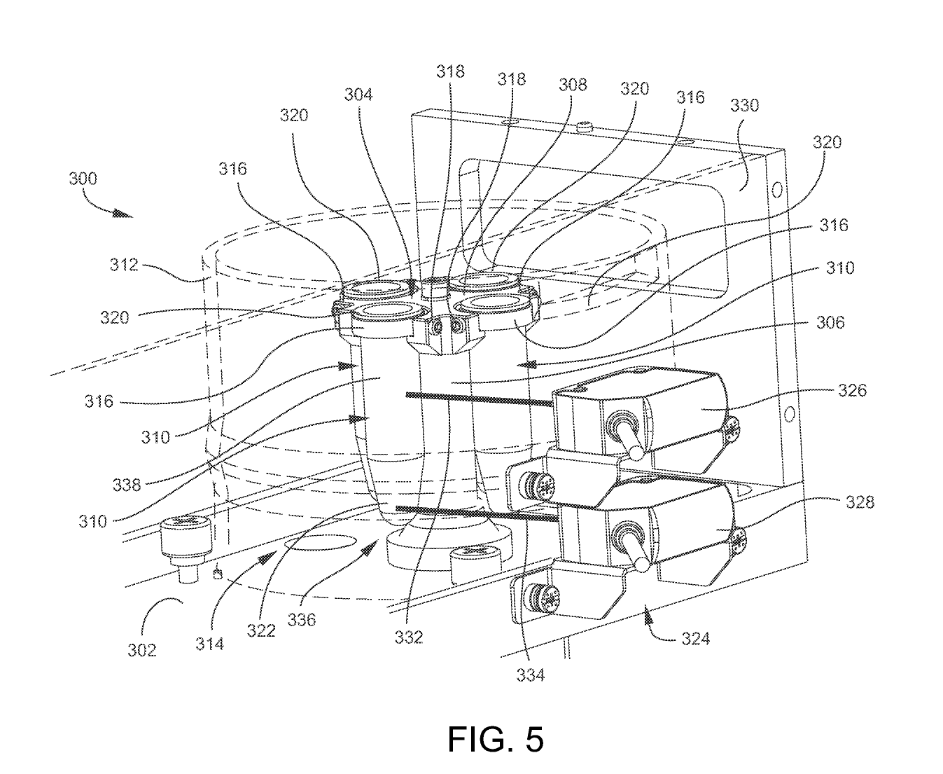

The automated centrifuge apparatus mitigates these risks by executing a series of tube status checks during the cell preparation procedure. Referring to FIG. 5, an example of an implementation of an automated centrifuge apparatus 300 is shown in a top perspective view. The automated centrifuge apparatus 300 may be mounted on a mounting frame 302, e.g., the process deck (102 in FIG. 1) of an automated high-throughput measurement system (100 in FIG. 1). The automated centrifuge apparatus 300, in this example, includes a rotor assembly 304 mounted to the top of a spindle 306. The rotor assembly 304, in this example, includes a rotor 308 that supports centrifuge tubes 310 such that the tubes 310 can pivot outward relative to the rotor assembly 304 when the rotor assembly 304 spins about a central axis. A spin housing 312 may be mounted to the mounting frame 302 and surround the rotor assembly 304 and centrifuge tubes 310 thereby defining a spin area 314. The spin housing 312, in this example, is a vertical cylindrical wall that surrounds the centrifuge tubes 310 and rotor assembly 304. The spin housing 312, in this example, may also function as a splash guard to contain any spills or sprays from overfilled centrifuge tubes 310.

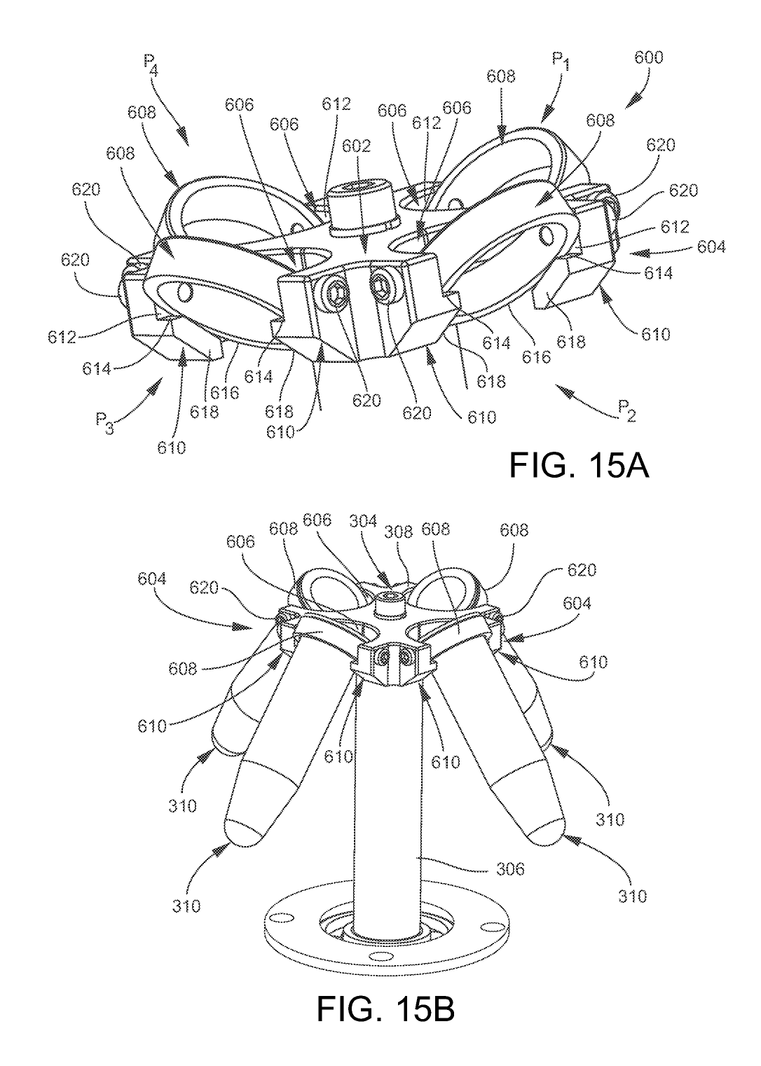

The rotor 308 of the rotor assembly 304, in this example, supports four centrifuge tubes 310 at four respective tube locations around the perimeter of the rotor 308. At each tube location, in this example, a collar recess (FIG. 15A) is formed in the rotor 308 for receipt of a collar 316 that holds the centrifuge tubes 310. A pair of pivot pins 318 respectively secures each of the collars 316 in a respective collar recess of the rotor 308. The collar 316, in this example, is an annular ring through which a centrifuge tube 310 may be inserted. Accordingly, the collar recess is shaped to receive the collar 316. The collar recesses, in this example, have a semicircular shape to receive the annular shape of the collar 316.

A rim 320 surrounding the top of the centrifuge tube 310 may rest on the upper surface of the collar 316. In this way, the collar 316 secures the centrifuge tubes 310 to the rotor 308. As the rotor assembly 304, in this example, supports four centrifuge tubes 310, the rotor assembly 304 shown by way of example in FIG. 5 accordingly includes four collar recesses for respective receipt of four collars 316 that are respectively supported in the recesses via a pair of pivot pins 318 thus totaling eight pivot pins. It will be understood that the rotor 308 may be configured to support more or less than four centrifuge tubes 310.

Additionally, the centrifuge tubes 310 may pivot about the pivot pins 318 in conjunction with the collar 316 when the rotor assembly 304 is spun about a central axis. The collar recesses of the rotor 308 are sized to permit the collar 316 and tube 310 to pivot in the collar recess. The automated centrifuge apparatus 300 may pelletize cells contained in the centrifuge tubes 310 by rotating the rotor assembly 304 at a relatively fast speed. Centrifugal forces draw the lower end 322 of the tubes 310 outward away from the rotor assembly 304. Centrifugal forces also draw cells in the tubes 310 toward the lower end 322 of the tube 310 where they may collect together in a mass of cells that may be referred to as a pellet.

The automated centrifuge apparatus 300 also includes a sensor module 324 that monitors the status of tubes 310 supported in the rotor assembly 304 during the cell preparation procedure. The sensor module, in this example, includes two sensors 326 and 328. As seen in FIG. 5, the sensor module 324 may include an upper sensor 326 and a lower sensor 328 situated directly below the upper sensor 326. The sensors 326 and 328 may be for example, optical sensors and configured to monitor the status of the centrifuge tubes 310 within the spin housing 312. The optical sensors 326 and 328 may be mounted to the mounting frame 302 or a vertical mounting wall 330 that is mounted to the mounting frame 302. As shown by way of example in FIG. 5, an upper optical sensor 326 is mounted to a vertical mounting wall 330, and a lower optical sensor 328 is mounted to the mounting frame 302.

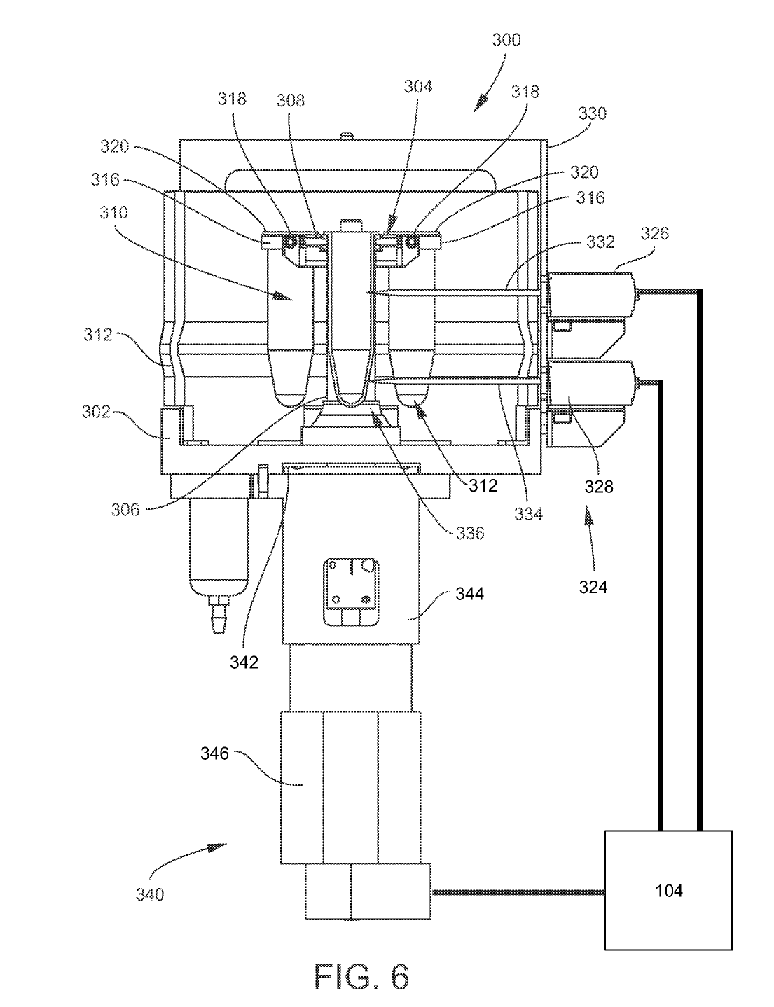

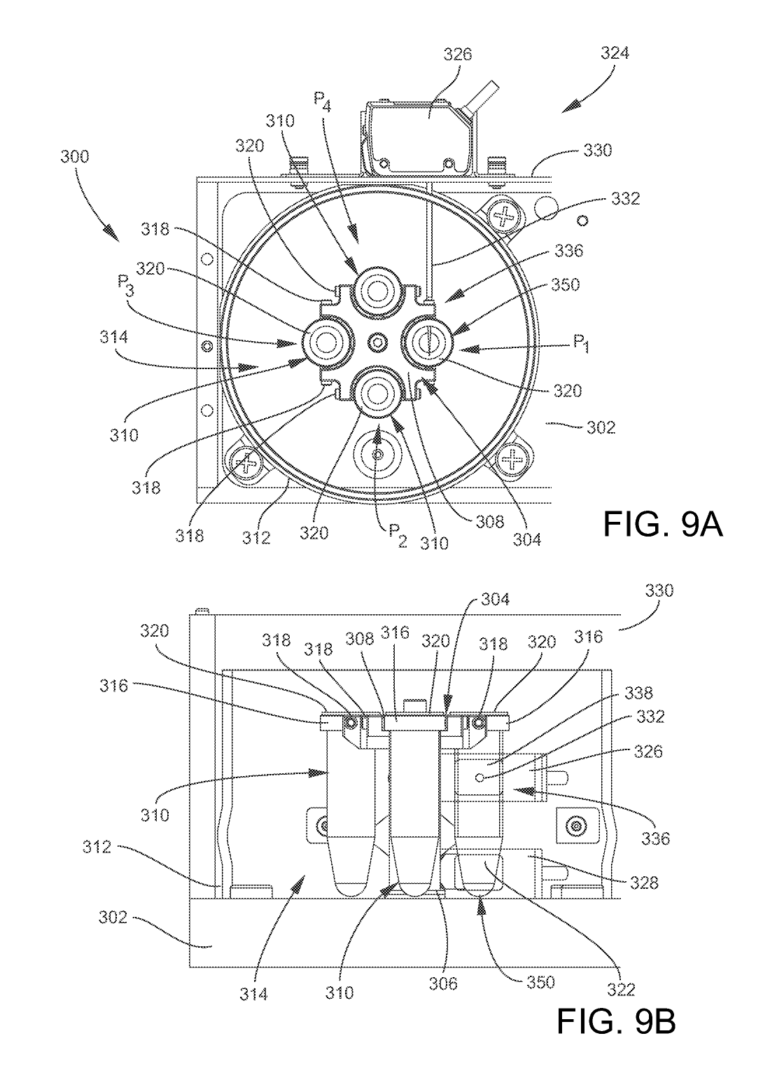

Each optical sensor 326 and 328, in this example, directs a respective laser beam 332 and 334 into the spin area 314 to monitor the status of the centrifuge tubes 310. Accordingly, the mounting wall 330 and spin housing 312, in this example, are transparent in order to permit the laser beams 332 and 334 from the sensors 326 and 328 to enter into the spin area 314. A rotary actuator (FIG. 6) may rotate the rotor assembly 304 to index tube positions (FIG. 9A) on the rotor 308 to an index location 336 within the spin area 314. A tube position of the rotor 308 that is indexed to the index location 336 (i.e., located at the index location 336) may be referred to as an indexed tube position. When a centrifuge tube 310 is installed at an indexed tube position, i.e., when the centrifuge tube 310 is located at the index location 336, the centrifuge tube 310 may similarly be referred to as an indexed centrifuge tube. A centrifuge tube 310 may be indexed to the index location that is situated in the path of each laser beam 332 and 334. The measurements for the various tube status checks may thus be taken at this index location 336.

As seen in FIG. 5, the upper optical sensor 326, in this example, is positioned directly above the lower optical sensor 328. Accordingly, the upper optical sensor 326 may direct an upper laser beam 332 toward an upper end 338 of a centrifuge tube 310 located at the index location 336, and the lower optical sensor 328 may direct a lower laser beam 334 toward a lower end 322 of the tube 310 located at the index location 336.

The optical sensors 326 and 328 may be, for example, reflective laser sensors that detect a tube 310 at the index location 336 by directing a respective laser beam 332 and 334 at the index location 336 and monitoring any reflections received. The laser beams 332 and 334, in this example, may have a wavelength of around 660 nanometers (nm). If the optical sensors 326 and 328 receive a respective reflection, then the optical sensors 326 and 328 may generate a signal indicating that a tube 310 was detected at the index location 336. The reflective laser sensors 326 and 328 may respectively include a laser light source (e.g., a laser diode) to generate the respective laser beams 332 and 334 and a respective image sensor (e.g., a CMOS image sensor) to receive any reflections. The optical sensors 326 and 328 of the sensor module 324 may be positioned at an operative distance (i.e., working distance) away from the index location 336. The operative distance may be between 35 mm and 100 mm and, in some example implementations, around 55 mm. The operative distance may be selected such that the portion of the spin housing 312 situated opposite the optical sensors 326 and 328 is positioned beyond the operative distance of the optical sensors 326 and 328 so as to prevent reflections of the laser beams 332 and 334 off the spin housing 312 from returning to and triggering the optical sensors 326 and 328. Suitable optical sensors 326 and 328 for monitoring the status of centrifuge tubes 310 in the rotor assembly 304 of the automated centrifuge apparatus 300 may be available from Keyence Corporation of Osaka, Japan as, for example, part number LR-ZB100N. Referring now to FIG. 6, the example implementation of the automated centrifuge apparatus 300 of FIG. 5 is shown in a side view. As seen in FIG. 6, the rotor assembly 304 is coupled to a rotary actuator 340 via an opening 342 through the mounting frame 302. An actuator housing 344 may mount the rotary actuator 340 to the mounting frame 302. The rotary actuator 340 may include a motor 346 for driving rotation of the rotor assembly 304 about a central axis as discussed above. A suitable rotary actuator 340 may be available from Maxon Precision Motors, Inc. of Fall River, Mass. as part number 312336.

The rotary actuator 340 may be coupled to a control module 104 that controls the motor 346 of the rotary actuator 340. In this way, the control module 104 may control the rotational speed of the centrifuge tubes 310. The optical sensors 326 and 328 of the sensor module 324 may also be coupled to the control module 104. Accordingly, the optical sensors 326 and 328 may communicate digital logic signals to the control module 104 during the tube status checks. As discussed further below, the control module 104 may perform various actions in response to receipt of signals from the sensor module 324. The control module 104, in this example, may be the control module 104 discussed above with reference to FIG. 1.

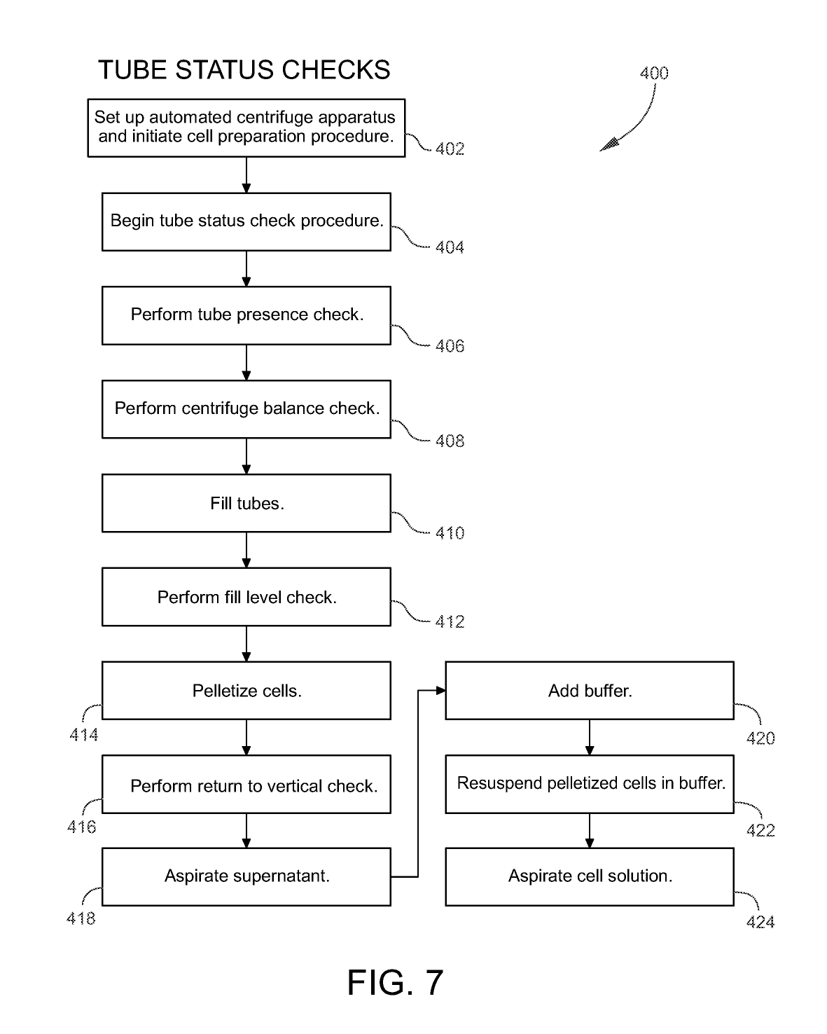

Referring now to FIG. 7, a flowchart 400 of example method steps for a cell preparation method that includes tube status check procedures are shown. The tube status checks ensure that the centrifuge tubes are present, filled, and free-swinging for the cell preparation process. In this example, the sensing module of the automated centrifuge apparatus monitors the position of the centrifuge tubes in the automated centrifuge apparatus in order to determine whether the tube status checks are satisfied.

An operator may set up the automated centrifuge apparatus and initiate the cell preparation procedure (step 402) as discussed above with reference to FIG. 4. Once the cell preparation procedure has been initiated, the automated centrifuge apparatus may begin the tube status check procedure (step 404). The automated centrifuge apparatus, in this example, first performs a tube presence check (step 406) in order to determine whether a tube has been installed at each tube location on the rotor of the rotor assembly. The tube presence check guards against delivering cell solution into a vacant tube position at the rotor.

Following the tube presence check, the automated centrifuge apparatus, in this example, performs a centrifuge balance check (step 408). If a centrifuge tube is missing from the rotor assembly (e.g., if zero, one, or three tubes are mounted in the rotor of the rotor assembly), then the centrifuge may become unbalanced when the rotor assembly and tubes are rotated. As discussed further below, the rotor assembly may include only two centrifuge tubes, but the tubes should be positioned opposite one another in the rotor of the rotor assembly (i.e., 180 degrees relative to each other) in order achieve a balanced centrifuge. The centrifuge balance check ensures that if the rotor of the rotor assembly only includes two centrifuge tubes, the two centrifuge tubes are positioned at diagonally opposite tube positions to ensure a balanced centrifuge. If two centrifuge tubes are installed at the rotor assembly at adjacent tube positions, then the automated centrifuge apparatus is considered to be unbalanced in this example. Maintaining a balanced centrifuge can advantageously improve the lifespan of the centrifuge.

After the balance check, the automated centrifuge apparatus, in this example, may fill the centrifuge tubes (step 410) and perform a fill level check (step 412), by rotating the tubes at a relatively slow speed, in order to determine whether the tubes contain a sufficient amount of cell solution. The fill level check ensures that an appropriate amount of cell solution is processed so that assays are not compromised by having insufficient cell solution and too low of a cell count.

After the fill level check, the automated centrifuge apparatus, in this example, pelletizes the cells (step 414) by rotating the tubes at a relatively fast speed as discussed above. Rotating the centrifuge tubes at a relatively fast speed causes the centrifuge tubes to pivot away from the rotor assembly during rotation. During rotation, the tubes pivot about the pivot pins to move from a vertical orientation to an angled orientation relative to the rotor assembly. It will be understood that “vertical orientation” also refers to a near vertical (or substantially vertical) orientation. As the rotation of the centrifuge tubes slows to a stop, the tubes should pivot back toward the rotor assembly to return to a vertical orientation. In order for the cell pipettor (FIG. 17) to aspirate the supernatant from the centrifuge tubes, the tubes should be oriented in a vertical position in order to receive the cell pipettor.

In some circumstances, a centrifuge tube may remain in an angled orientation after cell pelletization. In other words, a centrifuge tube may not return to a vertical or near vertical orientation after cell pelletization and may not be properly oriented to receive the cell pipettor. Accordingly, the automated centrifuge apparatus, in this example, performs a return to vertical check (step 416) in order to determine whether each tube has returned to a vertical or near vertical position after cell pelletization.

A centrifuge tube that does not return to vertical may indicate a need to clean the rotor assembly, in particular, the collar and pivot pins of the tube that failed to return to vertical. Moreover, a centrifuge that does not return to vertical may also indicate that the tube is at risk of remaining in a vertical orientation during cell pelletization instead of pivoting toward an angled orientation, which may result in poor pelletization of the cells.

If the automated centrifuge apparatus determines that each of the centrifuge tubes successfully returned to a vertical orientation, then the tubes may reliably receive the cell pipettor to aspirate the supernatant (step 418). Once the supernatant is aspirated from the tube, buffer may be added to the tube (step 420), and the pelletized cells may be resuspended in the buffer (step 422). Once the cells are resuspended in the buffer, the cell solution may be aspirated from the tube (step 424).

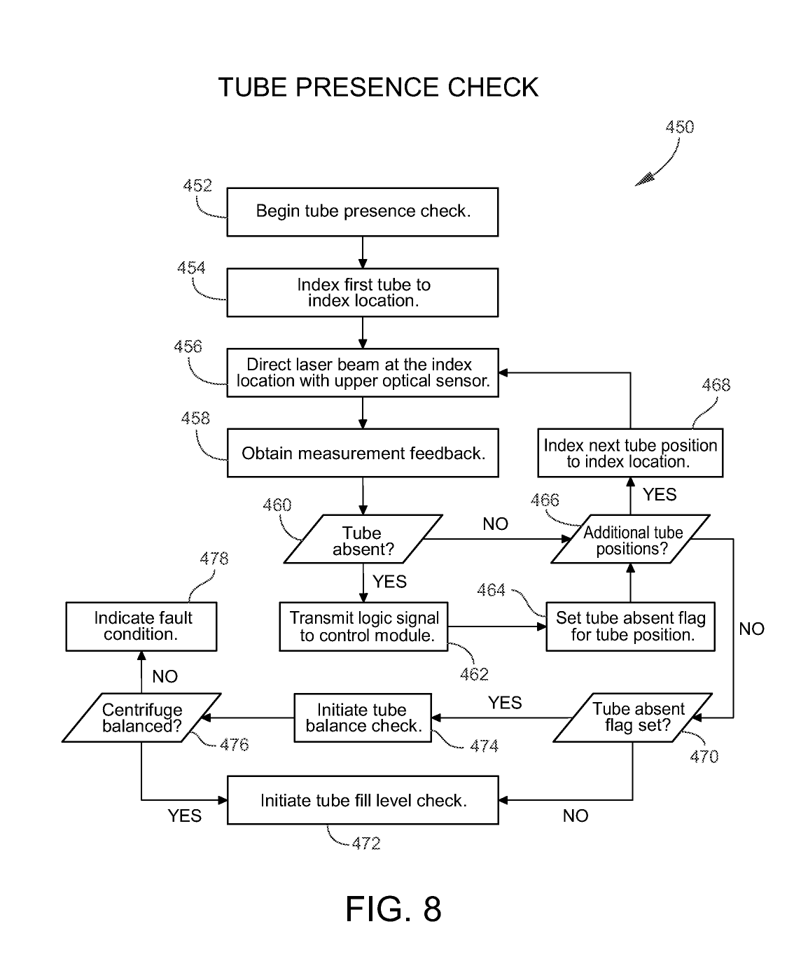

Referring now to FIG. 8, a flowchart 450 of example method steps of a tube presence check procedure are shown. The tube presence check determines whether the operator has installed the centrifuge tubes at the rotor assembly of the automated centrifuge apparatus before the cell handling unit dispenses the cell solution at the tube positions of the rotor assembly. The tube presence check procedure will be discussed with additional reference to FIG. 9A and FIG. 9B that illustrate the operation of the automated centrifuge apparatus 300 during the tube presence check. After the initiation of the tube presence check (step 452), the automated centrifuge apparatus 300 indexes a first tube 350 to the index location 336 (step 454). As mentioned above a centrifuge tube indexed to the index location 336 may be referred to as an indexed centrifuge tube. The automated centrifuge apparatus 300 may index the tubes 310 and 350 by activating the rotary actuator (340 in FIG. 6), and the motor (346 in FIG. 6) of the rotary actuator 340 may rotate the rotor 308 of the rotor assembly 304 to place a first tube 350 at the index location 336 as shown by way of example in FIG. 9A and FIG. 9B.

The rotor 308 of the rotor assembly 304, in this example, includes four tube positions as mentioned above. As seen in the top view of the automated centrifuge apparatus 300 in FIG. 9A, the four tube positions of the rotor 308, in this example, may be described as being respectively located at the four sides of the rotor 308. In this example, the tube positions of the rotor 308 are identified as tube position P₁, tube position P₂, tube position P₃, and tube position P₄. As shown by way of example in FIG. 9A, tube position P₁ is the current indexed tube position, and the centrifuge tube 350 situated at tube position P₁ is the current indexed centrifuge tube.

With the first tube 350 at the index location 336, one of the optical sensors 326 and 328 of the sensor module 324 (e.g., the upper optical sensor 326) directs a laser beam 332 at the index location 336 (step 456). In this example, the upper optical sensor 326 of the sensor module 324 is used during the tube presence check. Accordingly, the upper optical sensor 326 may direct the laser beam 332 at the index location 336 to determine whether a centrifuge tube is present at the indexed tube position. If a centrifuge tube is present at the index location 336, then one of the optical sensors 326 and 328 (the upper optical sensor 326 in this example) may obtain measurement feedback (step 458). As seen in FIG. 9A and FIG. 9B, an indexed tube 350 is present at indexed tube position P₁. As mentioned above, the optical sensors 326 and 328 may be reflective laser sensors, and as seen in FIG. 9A and FIG. 9B, the indexed centrifuge tube 350 located at the index location 336 is situated in the path of the laser beam 332 from the upper optical sensor 326. Because a centrifuge tube 350 is present at the indexed tube position P₁, in this example, the laser beam 332 directed at the index location 336 reflects off the tube 350 back to the upper optical sensor 326.

While a sensor module 324 having two sensors 326 and 328 is shown by way of example in FIG. 9A and FIG. 9B, it will be understood that a sensor module having one sensor may be selectively employed to perform the tube presence check. In the present example, the upper sensor 326 of the sensor module 324 is employed to direct the laser beam 332 at the index location 336 such that the laser beam 332 from the upper sensor 326 strikes the widest part of the tube 350 near an upper end 338 of the indexed centrifuge tube 350. In this way, the upper sensor 326 of the sensor module 324 may detect the presence of the indexed centrifuge tube 350 at the indexed tube position (P₁ in this example) even when the indexed centrifuge tube 350 is slightly offset from a vertical orientation where the laser beam 332 from the upper sensor 326 strikes the indexed centrifuge tube 350 slightly off centerline. As mentioned above, however, a sensor module 324 having one optical sensor may be selectively employed to perform the tube presence check where the optical sensor directs the laser beam near a lower end 322 of the indexed centrifuge tube 350 rather than the wider upper end 338.

If a centrifuge tube is absent at the indexed tube position, P₁ in FIG. 9A, (step 460), the optical sensor 326 may generate a logic signal corresponding to an indication that a tube is absent at the indexed tube position, P₁ in FIG. 9A, and transmit that logic signal to the control module (104 in FIG. 6) (step 462). In response to receipt of the signal that a tube is missing at the indexed tube position, P₁ in FIG. 9A, the control module 104 may set an absent tube flag indicating that a tube is missing from the indexed tube position, P₁ in FIG. 9A, on the rotor 308 of the rotor assembly 304 (step 464). As mentioned above, the rotor assembly 304 may include only two centrifuge tubes 310 if the tubes are positioned opposite one another on opposite sides of the rotor 308 in order to ensure a balanced centrifuge apparatus 300. Accordingly, the control module 104 may wait to indicate a fault condition until the control module 104 determines whether or not the rotor 308 includes two tubes 310 positioned opposite each other.

If additional tube positions, P₂-P₄ in this example, remain to be checked (step 466), then the automated centrifuge apparatus 300 may index the next tube position, e.g., tube position P/, to the index location 336 (step 468). The automated centrifuge apparatus 300 may then repeat steps 456-460 in order to determine whether a tube is present at the next tube position, e.g., tube position P₂.

If there are no additional tube positions to check (step 466), then the control module 104 may determine whether one or more absent tube flags are set (step 470). If an absent tube flag is not set, then the optical sensor 326 detected a tube 310 and 350 at each of the tube positions, P₁-P₄ in this example, of the rotor 308. Accordingly, the control module 104 may determine that the rotor assembly 304 was properly loaded, and the tube fill level check may be initiated (step 472).

If an absent tube flag is set, this may indicate that the rotor assembly 304 was loaded improperly. The rotor assembly 304 may be loaded improperly, in this example, where the rotor assembly 304 includes less than four tubes 310. The rotor assembly 304 may also be loaded improperly, in this example, where the rotor assembly 304 includes two tubes 310 that are not positioned opposite one another. To determine whether the rotor assembly 304 is balanced, the control module 104 may perform a balance check to determine whether the centrifuge apparatus 300 is balanced (step 474).

If the centrifuge apparatus 300 is not balanced (step 476), then the control module 104 may determine that the rotor assembly 304 was loaded improperly and indicate a fault condition (step 478). The control module 104 may indicate the fault condition to an operator by displaying an error message on the display device mentioned above with reference to FIG. 1. In response to receipt of the error message, an operator may check the rotor assembly 304 and install a respective centrifuge tube 310 in any tube positions, P₁-P₄ in this example, that are missing centrifuge tubes. The operator may then reinitiate the tube presence check.

If the centrifuge apparatus 300 is balanced (step 476), i.e., if the control module 104 determines that the rotor assembly 304 includes two tubes 310 positioned opposite each other, then the control module 104 may determine that the rotor assembly 304 was properly loaded, and the tube fill level check may be initiated (step 472).

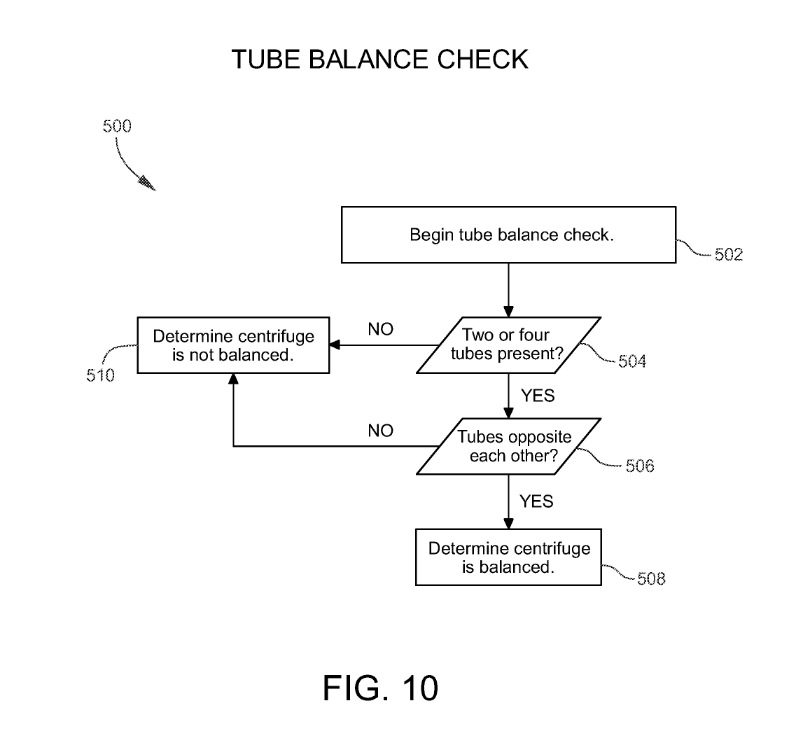

Referring to FIG. 10, a flowchart 500 of example method steps for a tube balance check procedure are shown. The tube balance check determines whether the operator has installed the centrifuge tubes 310 in the rotor assembly 304 in a balanced configuration. As mentioned above with reference to FIG. 8, the control module (104 in FIG. 6) may initiate a tube balance check (step 502) when an absent tube flag is set. If an absent tube flag is set, at least one tube 310 is absent from the rotor assembly 304. In other words, the rotor assembly 304 includes three or less tubes 310 when an absent tube flag is set. If the rotor assembly 304 includes two tubes 310, however, the centrifuge apparatus 300 may nonetheless be balanced where the tubes 310 are positioned opposite one another.

Accordingly, if two tubes 310 are present (step 504), the control module 104 determines whether the tubes 310 are positioned opposite one another (step 506). If the tubes 310 are positioned opposite one another, then the control module 104 may determine that the centrifuge apparatus 300 is balanced (step 508). As a result, the control module 104, in this example, may not indicate a fault condition where the rotor 308 of the rotor assembly 304 includes two tubes 310 positioned opposite one another. Referring back to FIG. 9A, the control module (104 in FIG. 6) will determine that the centrifuge apparatus 300 is balanced when: a) the rotor 308 includes two tubes 310 at tube position P₁ and tube position P₃; or b) the rotor 308 includes two tubes 310 at tube position P₂ and tube position P₄. The control module 104 will determine that the centrifuge apparatus 300 is not balanced when the rotor 308 includes two tubes 310 at: a) tube position P₁ and tube position P₂; b) tube position P₂ and tube position P₃; c) tube position P₃ and tube position P₄; or d) tube position P₄ and tube position P₁.

If an absent tube flag is set and two tubes 310 are not present (step 504), then the rotor assembly 304 is missing either one tube 310, three tubes 310, or four tubes 310, and the control module 104 may determine that the centrifuge apparatus 300 is not balanced (step 510). As explained above, if the centrifuge apparatus 300 is not balanced, the control module 104 may display an error message to indicate a fault condition.

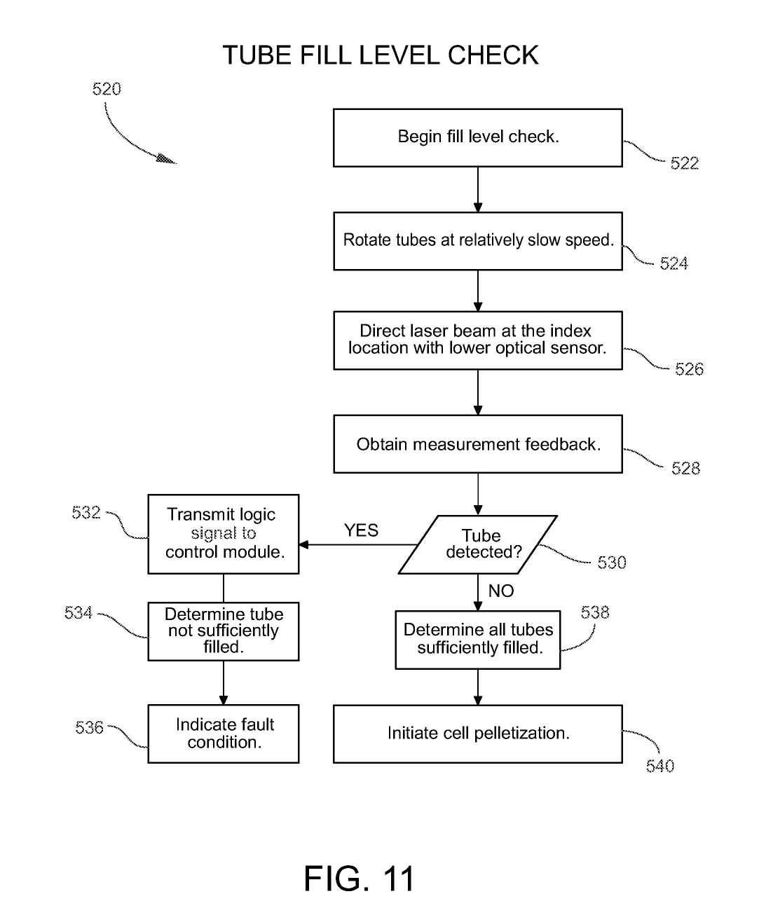

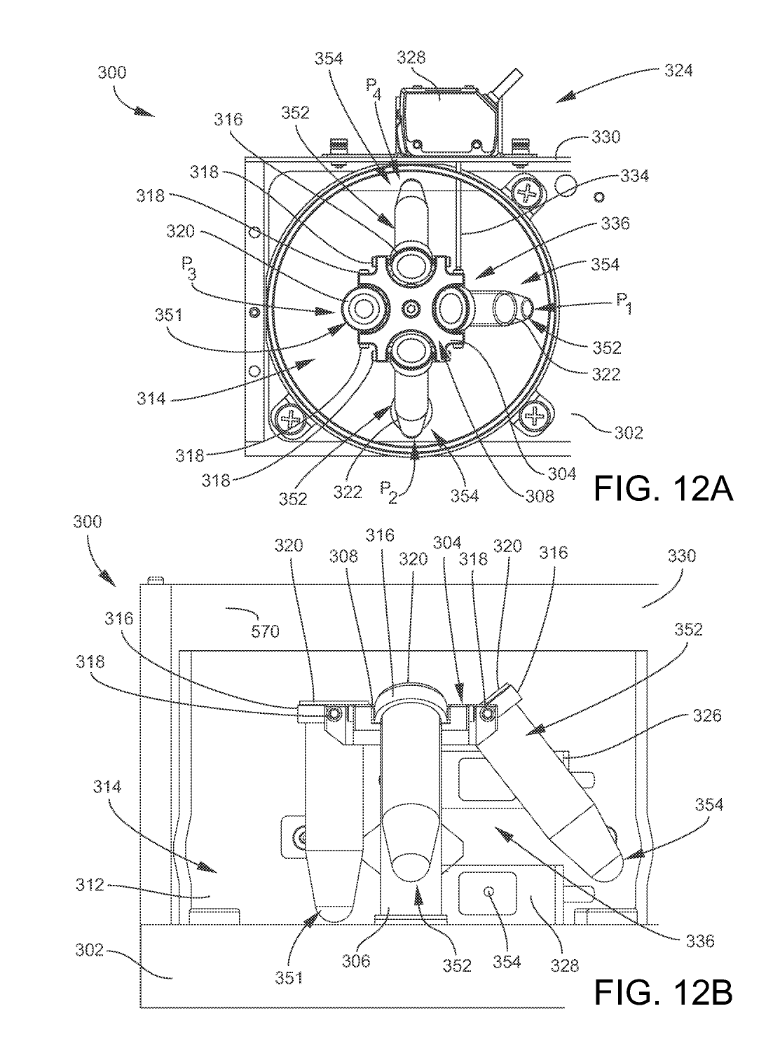

If the centrifuge tubes 310 are present and if the centrifuge apparatus 300 is balanced, then the cell pipettor (FIG. 17) may dispense cell solution into the tubes 310. The automated centrifuge apparatus 300 may perform a fill level check to ensure the centrifuge tubes 310 contain a sufficient amount of cell solution. The fluid fill level check may also serve as a balance check to guard against imbalances caused by inconsistently filled centrifuge tubes 310. Referring to FIG. 11, a flowchart 520 of example method steps for a fill level check procedure are shown. The fill level check determines whether the centrifuge tubes include a sufficient amount of cell suspension before cell pelletization is performed. The fill level check procedure will be discussed with additional reference to FIG. 12A and FIG. 12B that illustrate the operation of the automated centrifuge apparatus 300 during the fill level check.

After the cell pipettor (FIG. 17) dispenses the cell solution into the tubes 351 and 352, the automated centrifuge apparatus 300 may initiate the fill level check (step 522). The automated centrifuge apparatus 300 may rotate the centrifuge tubes 351 and 352 at a relatively slow speed (step 524), i.e., at a speed slower than what would be used to pelletize the cells. A relatively slow speed may be, for example, around 30-50 rotations per minute (rpm).

As the rotor assembly 304 rotates at the relatively slow speed, the centrifuge tubes 352 may pivot to an angled orientation relative to the rotor assembly 304 as centrifugal forces pull the lower end 322 of the tubes 352 outward to an angled orientation relative to a vertical orientation. The angled orientation of the tubes 352 during the relatively slow speed spin may be referred to as a low-speed “flyout” position 354. The low-speed flyout position 354 may be, for example, around 10° relative to a vertical orientation. Centrifuge tubes 352 will pivot to the low-speed flyout position 354 if the tubes 352 contain a sufficient amount of cell solution. If a centrifuge tube, e.g. centrifuge tube 351, does not include a sufficient amount of cell solution, i.e., includes less than a sufficient amount of cell solution, then the tube 351 will remain in a vertical orientation as seen in FIG. 12A and FIG. 12B. In other words, the fill level of the centrifuge tubes 351 and 352 may determine whether the centrifuge tubes 351 and 352 pivot to the flyout position 354 during the low speed spin. If a centrifuge tube is filled to contain a sufficient amount of cell solution, e.g., centrifuge tubes 352, then the centrifuge tubes 352 pivot outward to the flyout position 354 during the low-speed spin. If a centrifuge tube is filled to contain an amount of cell solution less than the sufficient amount of cell solution (or not filled at all), e.g., centrifuge tube 351, then the centrifuge tube 351 may fail to pivot outward to the flyout position 354 during the low-speed spin. A sufficient amount of cell solution that results in the centrifuge tubes 352 pivoting to the low-speed flyout position 354 during the relatively slow speed spin may be, for example, around 4.5 milliliters (ml). It will be understood, however, that alternative volumes of cell solution may be selectively considered to be a sufficient amount of cell solution. Additionally, the low-speed flyout position 354 may selectively correspond to alternative angles relative to a vertical orientation. Where a relatively larger volume of cell solution is considered to be a sufficient amount of cell solution, the low-speed flyout position 354 may correspond to a relatively larger angle with respect to a vertical orientation; and where a relatively smaller volume of cell solution is considered to be a sufficient amount of cell solution, the low-speed flyout position 354 may correspond to a relatively smaller angle with respect to a vertical orientation. Moreover, the sensor module 324 may be laterally adjusted relative to the index location 336 in order to detect centrifuge tubes 351 that fail to pivot to these alternative angles during the low-speed spin.

As shown by way of example in FIG. 12A and FIG. 12B, three of the centrifuge tubes 352 are oriented in the flyout position 354 while one of the centrifuge tubes 351 remains in a vertical orientation. In this example, the centrifuge tubes 352 at tube positions P₁, P₂, and P₄ are oriented in the flyout position 354, and the centrifuge tube 351 at tube position P₃ remains vertically oriented. One of the optical sensors 326 and 328 of the sensor module 324 is used to perform the fill level check. In this example, the lower optical sensor 328 is used to perform the fill level check. One of the optical sensors 326 and 328 of the sensor module 324 (e.g., the lower optical sensor 328) directs a laser beam 334 toward the index location 336 of the automated centrifuge apparatus 300 (step 52). As the tubes 351 and 352 rotate during the relatively slow speed spin, the lower optical sensor 328 obtains measurement feedback (step 528) as the centrifuge tubes 351 and 352 travel through the index location 336.

As seen in FIG. 12A and FIG. 12B, the centrifuge tubes 352 in the flyout position 354 will not cross the path of the laser beam 334 from the lower optical sensor 328 as the tubes 352 travel through the index location 336. In other words and as shown by way of example in FIG. 12B, the angled orientation of the tubes 352 in the flyout position 354 causes the tubes 352 to miss the laser beam 334 from lower optical sensor 328 as the tubes 352 pass through the index location 336. As a result, the tubes 352 will not reflect the laser beam 334 back to the lower optical sensor 328, i.e., the tubes 352 will not trigger the lower optical sensor 328 when the tubes 352 are in the flyout position 354.

The centrifuge tube 351 in a vertical orientation, however, will cross the path of the laser beam 334 from the lower optical sensor 328 as the tube 351 passes through the index location 336 as seen in FIG. 12B. In other words, the tube 351 in a vertical orientation will not miss the laser beam 334 from the lower optical sensor 328 as the tube 351 passes through the index location 336. As a result, the tube 351 reflects the laser beam 334 back to the lower optical sensor 328 when the tube 351 passes through the index location 336 thereby triggering the lower optical sensor 328.

If the lower optical sensor 328 detects a tube (step 530), e.g., centrifuge tube 351, then the optical sensor 328 may generate a logic signal corresponding to an indication that the tube 351 was detected at the index location 336 and transmit that logic signal to the control module (104 in FIG. 6) (step 532). The control module 104 may thus determine that one of the tubes, e.g., centrifuge tube 351, was not properly filled with cell solution (step 534), and indicate a fault condition (step 536). The control module 104 may indicate the fault condition to an operator by displaying an error message on the display device mentioned above with reference to FIG. 1. In response to receipt of the error message, an operator may check the centrifuge tubes 351 and 352 at the rotor assembly 304 and fill any tubes that do not have a sufficient amount of cell solution, centrifuge 351 in this example. The operator may then reinitiate the tube status checks.

If the optical sensor 328 does not detect a tube at the index location 336 during the relatively slow speed spin (step 530), then the control module 104 may determine that each centrifuge tube, e.g., centrifuge tubes 352 in FIG. 12A and FIG. 12B, includes a sufficient amount of cell solution (step 538), and the cell pelletization procedure may be initiated (step 540). During cell pelletization, the rotor assembly 304 and centrifuge tubes 351 and 352 may be rotated at a relatively high speed. Cell pelletization speeds may range from, for example, about 500 rpm to about 2,000 rpm, and a nominal cell pelletization speed may be around, for example, 1,620 rpm.

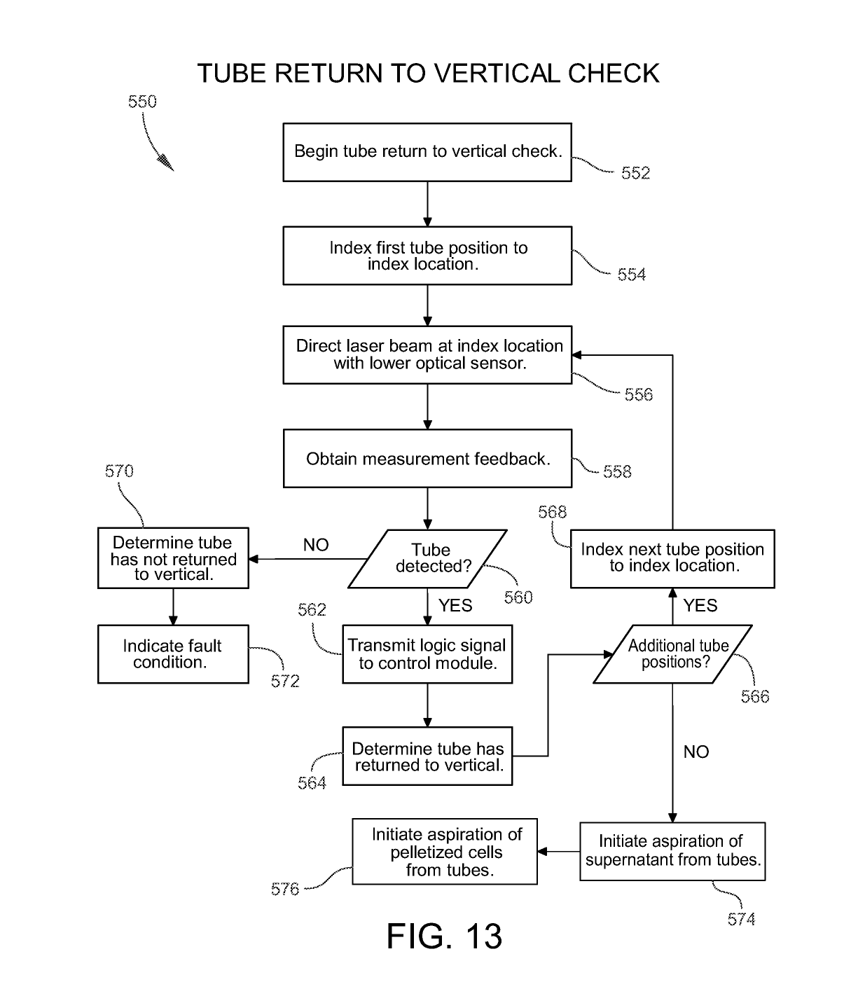

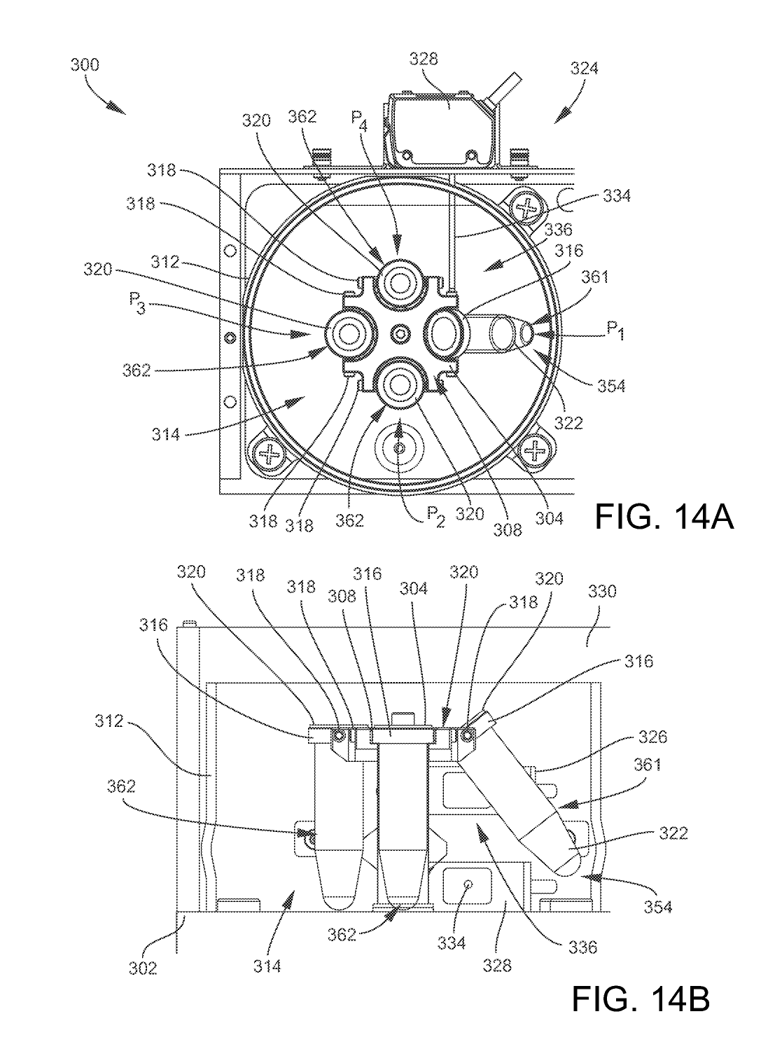

After cell pelletization, the automated centrifuge apparatus 300 performs a return to vertical check to ensure each of the centrifuge tubes 352 has returned to a vertical orientation from the flyout position 354. Referring to FIG. 13, a flowchart 550 of example method steps for a return to vertical check procedure are shown. The return to vertical check determines whether the centrifuge tubes have returned to a substantially vertical orientation following cell pelletization. The return to vertical check procedure will be discussed with additional reference to FIG. 14A and FIG. 14B that illustrate the operation of the automated centrifuge apparatus 300 during the return to vertical check.

After cell pelletization, the automated centrifuge apparatus 300 may initiate the return to vertical check (step 552). The automated centrifuge apparatus 300 may index the first tube position, e.g., tube position P₁, at the rotor 308 of the rotor assembly 304 to the index location 336 (step 554). One of the optical sensors 326 and 328 of the sensor module 324 (e.g., the lower optical sensor 328) directs a laser beam 334 at the index location 336 (step 556) to determine whether the centrifuge tube at the indexed tube position has returned to a substantially vertical orientation. In this example, the centrifuge tube 361 at tube position P₁ is the indexed centrifuge tube. If a centrifuge tube is present at the index location 336, the optical sensor 328 obtains measurement feedback (step 558) as the laser beam 334 is reflected off the tube back towards the optical sensor 328. Like the fill level check, the automated centrifuge apparatus 300, in this example, uses the lower optical sensor 328 perform the return to vertical check.

A centrifuge tube, e.g., centrifuge tube 361 in FIG. 14A and FIG. 14B, that fails to return to a substantially vertical orientation but instead remains in the flyout position 354 after cell pelletization will fail to cross the path of the laser beam 334 from the lower optical sensor 328. As shown by way of example in FIG. 14A and FIG. 14B, three of the centrifuge tubes 362 have returned to a vertical orientation following cell pelletization, and one centrifuge tube 361 remains in the flyout position 354. As seen in FIG. 14B, the centrifuge tube 361 in the flyout position 354 misses the laser beam 334 from the lower optical sensor 328 at the index location 336 due to the angled orientation of the tube 361. In some example implementations, a centrifuge tube that is oriented, for example, around 10° off the vertical axis may miss the laser beam 334 from the lower optical sensor 328, thus indicating that the tube did not return to a substantially vertical orientation.

A centrifuge tube, e.g., centrifuge tubes 362, that does return to a vertical orientation will cross the path of the laser beam 334 from the lower optical sensor 328 as seen in FIG. 14B. As a result, the laser beam 334 will reflect off the vertically oriented tubes 362 at the index location 336 thereby triggering the optical sensor 328.

If a tube 362 is detected at the index location 336 (step 560), i.e., if a tube 362 at the index location 336 triggers the optical sensor 328, the optical sensor 328 may generate a logic signal indicating that a tube 362 was detected and transmit the logic signal to the control module (104 in FIG. 6) (step 562). In response to receipt of the logic signal from the optical sensor 328, the control module 104 may determine that the tube 362 at the index location 336 has returned to a vertical orientation (step 564). If the rotor 308 includes additional tube positions to check, e.g., tube positions P₂-P₄, (step 566), then the automated centrifuge apparatus 300 may index to the next tube position, e.g., tube position P₂, of the rotor 308 (step 568) and repeat steps 556-560 in order to determine whether the centrifuge tube at the next tube position has returned to a vertical orientation.

If a tube, e.g., centrifuge tube 361, is not detected at the index location 336 (step 560), i.e., if the tube 361 at the index location 336 fails to trigger the optical sensor 328, then the control module 104 may fail to receive a logic signal from the optical sensor 328. If the control module 104 fails to receive a logic signal from the optical sensor 328, then the control module 104 may determine that the tube 361 at the index location 336 has not returned to a vertical orientation (step 570) and indicate a fault condition (step 572). As discussed above, the control module 104 may indicate the fault condition to an operator by displaying an error message on the display device mentioned above with reference to FIG. 1. In response to receipt of the error message, an operator may check the rotor assembly 304 and adjust any centrifuge tubes, e.g., centrifuge tube 361, that failed to return to a vertical orientation.

If there are no additional tube positions of the rotor 308 to check (step 566), then the automated centrifuge apparatus 300 may initiate aspiration of the supernatant from the tubes (step 574). Once the supernatant is removed from the tubes 361 and 362, the automated centrifuge apparatus 300 may initiate aspiration of the pelletized cells from the tubes (step 576). Because the automated centrifuge apparatus 300 checked that each tube 361 and 362 returned to a vertical orientation, the likelihood that the cell pipettor (FIG. 17) will be reliably received in the tubes 361 and 362 is advantageously improved.

Referring now to FIG. 15A and FIG. 15B, an example of an implementation of a rotor assembly 600 is shown. The rotor 602 of the rotor assembly 600 includes a pivot restrictor 604 to limit the outward pivot angle of a centrifuge tube 310 during rotation of the rotor assembly 600. Accordingly, the pivot restrictor 604 prevents the centrifuge tubes 310 from flying out to a horizontal position during the relatively high-speed spin to pelletize the cells. Each collar recess 606 may respectively include a pivot restrictor 604 to limit the pivot angle of the collar 608 situated in the collar recess 606 and a respective centrifuge tube 310 supported in the collar 608. By limiting the pivot angle of the collars 608 and corresponding centrifuge tubes 310, the spin envelope (i.e., footprint) of the automated centrifuge apparatus (300 in FIG. 5) may be advantageously minimized.

As shown by way of example in FIG. 15A, each tube position (P₁-P₄ in this example) of the rotor 602 includes a respective pivot restrictor 604. The collar 608 residing in the collar recess 606 engages the pivot restrictor 604 during rotation of the rotor assembly 600, and the pivot restrictor 604 limits the pivot angle of the collar 608 and centrifuge tube 310 secured in the collar 608. The pivot restrictor 604, in this example, includes a pair of mechanical stops 610 situated at the semicircular collar recess 606. The stops 610, in this example, are positioned at the outer edge of the rotor 602, i.e., the front of the collar recess. The stops 610 of the pivot restrictor, in this example, project away from the wall 612 of the collar recess 606 toward each other at respective ends of the collar recess 606 and are parallel with each other as shown by way of example in FIG. 15A. In other implementations, one stop may be included in each collar recess 606.

The stops 610 of the pivot restrictor 604, in this example, each include an upper landing 614 above which the lower surface 616 of the collar 608 is positioned when the axis of the collar 608 is in a vertical orientation, i.e., when the rotor assembly 600 is not spinning. The stops 610 of the pivot restrictor 604, in this example, also include a chamfer 618 that slopes downward into the collar recess 606 and towards the rear of the collar recess 606 as shown by way of example in FIG. 15A. As the collar 608 pivots about the pivot pins 620, the lower surface 616 of the collar 608 pivots towards the chamfer 618.

FIG. 15B illustrates the example implementation of the rotor assembly 600 of FIG. 15A in operation with a set of centrifuge tubes 310. As seen in FIG. 15B, the collars 608 respectively secured in the collar recesses 606 pivot about the pivot pins 620 during rotation. The lower surfaces 616 of the collars engage the respective chamfers 618 of the stops 610 of the pivot restrictors 604. Having come into contact with the chamfers 618, the collars 608 and tubes 310 cannot pivot any further. In this way, the pivot restrictors 604 limit the pivot angle of the collars 608 and the tubes 310 respectively secured in the collars 608. The chamfers 618 of the stops 610 of a pivot restrictor 604 may limit the pivot angle of a collar 608 to, for example, around 32 to around 40 degrees. In some example implementations, the pivot restrictor 604 may limit the pivot angle of a collar 608 to around 38 degrees thereby resulting in a maximum spin envelope of 111 mm in diameter. This relatively small spin envelope advantageously enables the automated centrifuge apparatus (300 in FIG. 5) to be installed at the process deck (102 in FIG. 1) of an automated high-throughput electrophysiology measurement system (100 in FIG. 1) for automated on-deck preparation of cell suspensions.

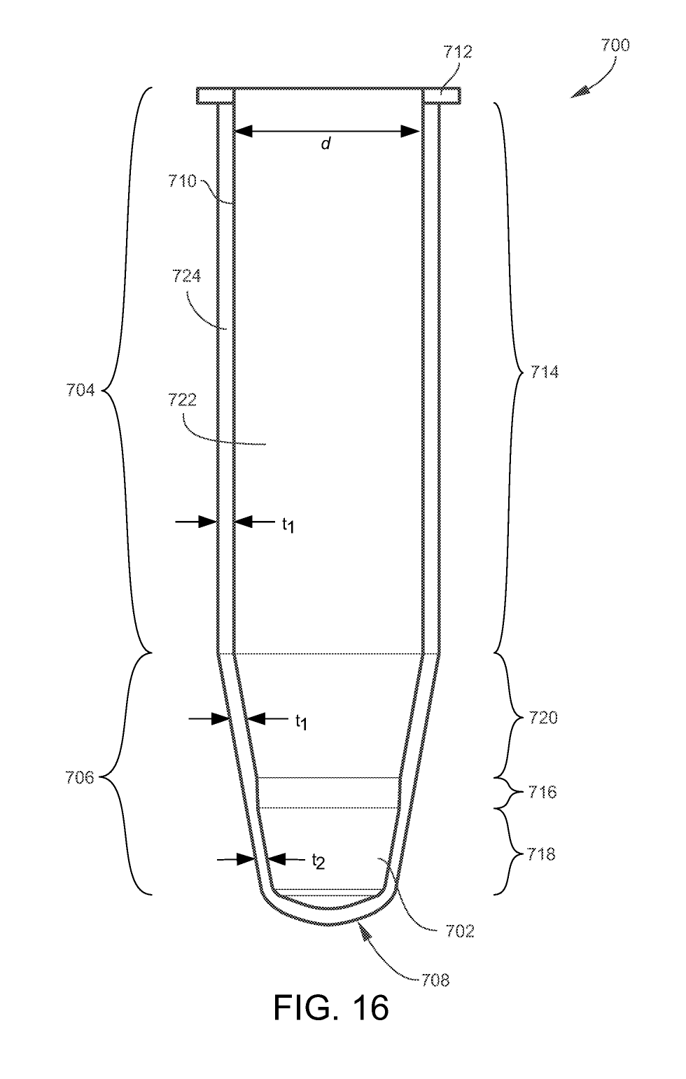

Referring now to FIG. 16, an example of an implementation of a centrifuge tube 700 that may be used in conjunction with the automated centrifuge apparatus (300 in FIG. 5) is shown in a front cross section. The centrifuge tube 700 includes an interior pocket 702 where pelletized cells can collect during the cell pelletization procedure. The pocketed centrifuge tube 700 advantageously protects the pelletized cells from being damaged or disturbed by the cell pipettor (FIG. 17) when the cell pipettor is received into the tube 700 to aspirate the supernatant. Because the pelletized cells are collected in the pocket 702 of the centrifuge tube 700 and thus positioned away from the cell pipettor, the likelihood that the cell pipettor will come into contact with the pelletized cells is reduced, particularly where the centrifuge tube 700 is not precisely oriented in a vertical orientation.

As seen in the front cross section of the pocketed centrifuge tube 700 in FIG. 16, the tube 700 includes a cylindrical upper portion 704, a conical lower portion 706, and a generally hemispherical bottom portion 708. The interior wall surface 710 of the pocketed centrifuge tube 700 defines an interior diameter, d. The pocketed centrifuge tube 700 also includes an annular rim 712 circumscribing the top of the cylindrical upper portion 704. The conical lower portion 706 of the pocketed centrifuge tube 700 tapers between the cylindrical upper portion 704 and the hemispherical bottom portion 708 as seen in FIG. 16. The lower portion 706 of the centrifuge tube 700 includes the interior pocket 702 that collects the pelletized cells. The lower portion 706 of the centrifuge tube 700 may selectively exhibit an alternate shape.

At the cylindrical upper portion 704 of the tube 700, the contour of the interior wall surface 710 defines an upper vertical region 714 in which the interior wall surface 710 is substantially vertical. Accordingly, the interior diameter, d, of the pocketed centrifuge tube 700 in the upper vertical region 714 is substantially uniform. At the conical lower portion 706 of the tube 700, the pocket 702 is defined by, in this example, a vertical transition region 716, a lower tapered region 718, and the interface between the vertical transition region 716 and an upper tapered region 720. As seen in FIG. 16, the vertical transition region 716 of the pocketed centrifuge tube 700, in this example, divides the conical lower portion 706 of the tube 700 to form the upper tapered region 720 and the lower tapered region 718. Accordingly, the contour of the interior wall surface 710 of the pocketed centrifuge tube 700 tapers between the upper vertical region 714 and the vertical transition region 716. As a result, the interior diameter, d, of the pocketed centrifuge tube 700 in the upper tapered region 720 also tapers from the upper vertical region 714 toward the vertical transition region 716. Likewise, the contour of the interior wall surface 710 of the pocketed centrifuge tube 700 at the lower tapered region 718 and the interior diameter, d, of the tube 700 in the lower tapered region 718 tapers down from the vertical transition region 716 toward the hemispherical bottom portion 708 of the tube 700.

Like the upper vertical region 714, the contour of the interior wall surface 710 at the vertical transition region 716 may be vertical or substantially vertical. For example, the contour of the interior wall surface 710 at the vertical transition region 716 may slightly taper at a small angle (relative to the vertical axis) that is different from the respective angles of the upper tapered region 720 and lower tapered region 718. In the illustrated example, the interior diameter, d, of the pocketed centrifuge tube 700 in the vertical transition region 716 may generally be no larger than any interior diameter, d, above it and no smaller than any interior diameter, d, below it. In other words, the interior diameter, d, of the vertical transition region 716 may match the smallest interior diameter, d, of the upper tapered region 720 and may match the largest interior diameter, d, of the lower tapered region 718 as shown by way of example in FIG. 16. In some example implementations, the vertical transition region 716 may have a small draft around 1° in order to permit removal of the molding tool that forms the interior cavity 722 of the tube 700.

Also seen in FIG. 16, the thickness of the wall 724 of the centrifuge tube 700, in this example, tapers in the lower portion 706 of the tube 700 and accordingly is comparatively thinner at the lower portion 706 of the tube relative to the upper portion 704 of the tube 700. As shown by way of example in FIG. 16, the thickness of the centrifuge tube wall 724 begins to taper in the vertical transition region 716 of the lower portion 706 of the centrifuge tube 700. Accordingly, the thickness, t₁, of the centrifuge tube wall 724 at the upper vertical region 714 and the upper tapered region 720, in this example, is relatively larger than the thickness, t₂, of the centrifuge tube wall 724 in the lower tapered region 718 of the lower portion 706 of the tube 700. As a result, the lower tapered region 718 defines a pocket 702 circumscribing the interior of the centrifuge tube 700 at the lower portion 706. For example, the thickness, t₁, of the centrifuge tube wall 724 at the upper vertical region 714 and at the upper tapered region 720 may be around 1.0 mm, and the thickness, t₂, of the centrifuge tube wall 724 at the lower tapered region 718 may be around 0.7 mm.

In other implementations, the pocket 702 may be defined in a manner that does not entail changing the thickness of the centrifuge tube wall 724, or in a manner that is independent of the thickness of the centrifuge tube wall 724. For example, the centrifuge tube 700 may be fabricated in a manner that shapes the tube wall 724 so as to obtain an internal contour defining a pocket 702 as described above and illustrated in FIG. 16, but without needing to alter the wall thickness.

Referring to FIG. 17, a close-up cross-sectional view of the pocketed centrifuge tube 700 of FIG. 16 is shown. As seen in FIG. 17, a cell pipettor 726 has been inserted into the pocketed centrifuge tube 700 following cell pelletization. The pocketed centrifuge tube 700 receives the cell pipettor 726 in a pipettor receiving region 728 substantially near the center of the tube 700 such that the cell pipettor 726 can aspirate the supernatant from the tube 700. Pelletized cells 730 are collected in the pocket 702 of the centrifuge tube 700 as seen in FIG. 17 thus positioning the pelletized cells 730 away from the pipettor receiving region 728. In this way, the pocketed centrifuge tube 700 advantageously minimizes the chance that the cell pipettor 726 will come into contact with the pelletized cells 730 when the cell pipettor 726 is inserted into the tube 700.

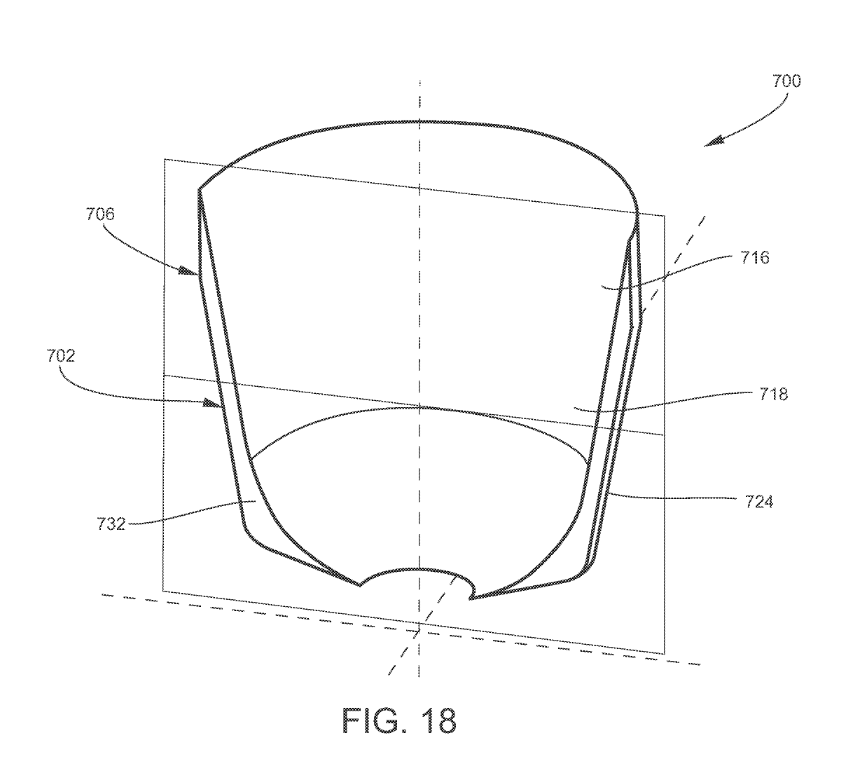

In FIG. 18, a top perspective cross-sectional view of the pocket 702 of an example of an implementation of a pocketed centrifuge tube 700 is shown. The cross-section 732 of the pocket 702, in this example, is highlighted to illustrate the position and configuration of the pocket 702 in the conical lower portion 706 of the pocketed centrifuge tube 700. A 360° sweep of the highlighted cross-section 732 around the interior of the wall 724 of the centrifuge tube 700 thus forms the pocket 702 that circumscribes the interior of the conical lower portion 706 of the pocketed centrifuge tube 700.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An automated method for monitoring an automated centrifuge apparatus during a cell preparation procedure, the method comprising:
conducting a set of status checks during the cell preparation procedure wherein the status checks relate to a plurality of centrifuge tubes installable at a rotor assembly of the automated centrifuge apparatus;
monitoring an index location at the automated centrifuge apparatus with a sensing module of the automated centrifuge apparatus during the cell preparation procedure;
determining whether individual status checks in the set of status checks are satisfied based on a status of individual centrifuge tubes of the plurality of centrifuge tubes positionable at the index location; and
indicating a fault condition in response to a determination that at least one of the status checks in the set of status checks is not satisfied.

2. The method of claim 1 wherein the status checks include at least one of:
a centrifuge tube presence check that automatically determines whether centrifuge tubes have been installed at respective centrifuge tube positions of the rotor assembly before cell suspension is dispensed at the tube positions of the rotor assembly;
a fill level check that automatically determines whether individual centrifuge tubes of the plurality of centrifuge tubes contain a predetermined amount of cell suspension before pelletizing cells in the cell suspension; and
a return to vertical check that automatically determines whether individual centrifuge tubes of the plurality of centrifuge tubes have returned to a substantially vertical orientation after cell pelletization.

3. The method of claim 2 wherein the centrifuge tube presence check includes:
indexing individual tube positions of the rotor assembly to the index location wherein the tube position indexed to the index location is an indexed tube position;
directing a laser beam at the index location using the sensing module such that the laser beam is reflected when a centrifuge tube is installed at the indexed tube position and such that the laser beam is not reflected when a centrifuge tube is not installed at the indexed tube position;
determining that a centrifuge tube is installed at the indexed tube position when the laser beam is reflected;
determining that a centrifuge tube is not installed at the indexed tube position when the laser beam is not reflected; and
determining that the centrifuge tube presence check is not satisfied in response to a determination that a centrifuge tube is not installed at at least one tube position of the rotor assembly.

4. The method of claim 3 further comprising:
conducting a balance check in response to a determination that a centrifuge tube is not installed at at least one tube position of the rotor assembly;
determining that the centrifuge tube presence check is satisfied in response to a determination that the automated centrifuge apparatus is balanced; and
determining that the centrifuge tube presence check is not satisfied in response to a determination that the automated centrifuge apparatus is not balanced.

5. The method of claim 4 wherein the balance check includes:
automatically determining whether zero, one, two, or three centrifuge tubes are installed at the rotor assembly of the automated centrifuge apparatus;
automatically identifying the tube positions of the rotor assembly at which respective centrifuge tubes are installed;
automatically determining that the automated centrifuge apparatus is balanced in response to a determination that two centrifuge tubes are installed at the rotor assembly at diagonally opposite tube positions;
automatically determining that the automated centrifuge apparatus is not balanced in response to a determination that two centrifuges tubes are installed at the rotor assembly at adjacent tube positions; and
automatically determining that the automated centrifuge apparatus is not balanced in response to a determination that zero, one, or three centrifuge tubes are installed at the rotor assembly.

6. The method of claim 2 wherein the fill level check includes:
spinning the rotor assembly of the automated centrifuge apparatus at a relatively slow speed such that a centrifuge tube filled to a first level and installed at the rotor assembly pivots to an angled orientation relative to a vertical orientation and such that a centrifuge tube filled to a second level less than the first level and installed at the rotor assembly does not pivot to the angled orientation;
directing a laser beam at the index location using the sensing module such that the centrifuge tube filled to the first level does not reflect the laser beam as the centrifuge tube filled to the first level travels through the index location and such that the centrifuge tube filled to the second level reflects the laser beam as the centrifuge tube filled to the second level travels through the index location;
determining that one of the centrifuge tubes is filled to the first level when the centrifuge tube does not reflect the laser beam while traveling through the index location;
determining that one of the centrifuge tubes is filled to the second level when the centrifuge tube reflects the laser beam while traveling through the index location; and
determining that the fill level check is not satisfied in response to a determination that at least one of the centrifuge tubes is filled to the second level.

7. The method of claim 2 wherein the return to vertical check includes:
indexing individual centrifuge tubes of the plurality of centrifuge tubes installed at respective tube positions of the rotor assembly to the index location;
directing a laser beam at the index location using the sensing module such that a vertically-oriented centrifuge tube reflects the laser beam when positioned at the index location and a non-vertically-oriented centrifuge tube does not reflect the laser beam when positioned at the index location;
determining that one of the centrifuge tubes is a vertically-oriented centrifuge tube when the laser beam is reflected while the centrifuge tube is positioned at the index location;
determining that one of the centrifuge tubes is a non-vertically-oriented centrifuge tube when the laser beam is not reflected while the centrifuge tube is positioned at the index location; and
determining that the return to vertical check is not satisfied in response to a determination that at least one of the centrifuge tubes is a non-vertically-oriented centrifuge tube.

8. An automated centrifuge apparatus for conducting a cell preparation procedure, the automated centrifuge apparatus comprising:
a rotor assembly configured to support a plurality of centrifuge tubes installable at a plurality of tube positions wherein the plurality of tube positions are indexable to an index location;
a sensing module configured to monitor the index location during a set of status checks wherein the status checks relate to the plurality of centrifuge tubes; and
wherein logic signals generated by the sensing module are used to automatically determine whether the status checks are satisfied.

9. The automated centrifuge apparatus of claim 8 wherein the rotor assembly includes:
a rotor that defines the plurality of tube positions;
a plurality of collars respectively attached to the rotor at respective tube positions wherein the collars are pivotable relative to the rotor and configured to receive and support respective centrifuge tubes; and
a plurality of pivot restrictors positioned on the rotor at respective tube positions wherein the pivot restrictors limit the collars to a predetermined pivot angle during rotation of the rotor assembly.

10. The automated centrifuge apparatus of claim 9 wherein:
the pivot restrictors each include a pair of mechanical stops that limit the collars to the predetermined pivot angle; and
each mechanical stop in the pair of mechanical stops includes a chamfer that engages a lower surface of the collars when the collars pivot during rotation of the rotor assembly such that movement of the collars beyond the predetermined pivot angle is restricted.

11. The automated centrifuge apparatus of claim 10 wherein the predetermined pivot angle is between approximately 32 degrees and approximately 40 degrees.

12. The automated centrifuge apparatus of claim 10 wherein the individual centrifuge tubes in the plurality of centrifuge tubes include:
a cylindrical upper portion;
a conical lower portion adjoining the cylindrical upper portion and comprising an upper tapering region, a vertical transition region positioned below the upper tapering region, and a lower tapering region positioned below the vertical transition region; and
an interior pocket formed at the conical lower portion and defined by the vertical transition region and the lower tapering region, wherein the interior pocket collects cells during cell pelletization such that the cells are positioned away from a pipettor when the pipettor is inserted into the centrifuge tube.

13. The automated centrifuge apparatus of claim 8 wherein the status checks include at least one of:
a centrifuge tube presence check that automatically determines whether centrifuge tubes have been installed at respective centrifuge tube positions of the rotor assembly before cell suspension is dispensed at the tube positions of the rotor assembly;
a fill level check that automatically determines whether individual centrifuge tubes of the plurality of centrifuge tubes contain a predetermined amount of cell suspension before pelletizing cells in the cell suspension; and
a return to vertical check that automatically determines whether individual centrifuge tubes of the plurality of centrifuge tubes have returned to a substantially vertical orientation after cell pelletization.

14. The automated centrifuge apparatus of claim 13 wherein:
the sensing module includes an upper sensor and a lower sensor;
the upper sensor is configured to conduct the centrifuge tube presence check; and
the lower sensor is configured to conduct the fill level check and the return to vertical check.

15. The automated centrifuge apparatus of claim 13 wherein the automated centrifuge apparatus is configured to:
index individual tube positions of the rotor assembly to the index location;
direct a laser beam at the index location using the sensing module such that the laser beam is reflected when a centrifuge tube is installed at the indexed tube position and such that the laser beam is not reflected when a centrifuge tube is not installed at the indexed tube position; and
generate a logic signal using the sensing module when the laser beam is reflected wherein the logic signal indicates that a centrifuge tube is installed at the indexed tube position.

16. The automated centrifuge apparatus of claim 13 further comprising a rotary actuator configured to spin the rotor assembly at a relatively slow speed such that an adequately-filled centrifuge tube installed at the rotor assembly pivots to an angled orientation relative to a vertical orientation and such that an inadequately-filled centrifuge tube installed at the rotor assembly does not pivot to the angled orientation and wherein:
the sensing module is configured to direct a laser beam at the index location such that an adequately-filled centrifuge tube does not reflect the laser beam as the adequately-filled centrifuge tube travels through the index location and such that an inadequately-filled centrifuge tube reflects the laser beam as the inadequately-filled centrifuge tube travels through the index location; and
the sensing module is configured to generate a logic signal when the laser beam is reflected wherein the logic signal indicates that at least one of the centrifuge tubes of the plurality of centrifuge tubes is an inadequately-filled centrifuge tube.

17. The automated centrifuge apparatus of claim 13 further comprising a rotary actuator configured to index individual centrifuge tubes of the plurality of centrifuge tubes installed at respective tube locations of the rotor assembly to the index position and wherein:
the sensing module is configured to direct a laser beam at the index location such that a vertically-oriented centrifuge tube reflects the laser beam when positioned at the index location and a non-vertically-oriented centrifuge tube does not reflect the laser beam when positioned at the index location; and
the sensing module is configured to generate a logic signal when the laser beam is reflected wherein the logic signal indicates that at least one of the centrifuge tubes of the plurality of centrifuge tubes is a non-vertically-oriented centrifuge tube.

18. A centrifuge tube for use in an automated centrifuge apparatus during a cell preparation procedure, the centrifuge tube comprising:
a cylindrical upper portion;
a conical lower portion adjoining the cylindrical upper portion; and
an interior pocket formed at the conical lower portion wherein the interior pocket collects cells during cell pelletization such that the cells are positioned away from a pipettor when the pipettor is inserted into the centrifuge tube.

19. The centrifuge tube of claim 18 wherein:
the conical lower portion comprises an upper tapering region, a vertical transition region positioned below the upper tapering region, and a lower tapering region positioned below the vertical transition region;
the interior pocket is defined by the vertical transition region and the lower tapering region;
an interior diameter of the centrifuge tube tapers in the upper tapering region toward the vertical transition region;
the interior diameter is substantially uniform in the vertical transition region; and
the interior diameter tapers in the lower tapering region down from the vertical transition region.

20. The centrifuge tube of claim 19 wherein:
a centrifuge tube wall defines the cylindrical upper portion and the conical lower portion;
the centrifuge tube wall has a first thickness at the upper tapering region of the conical lower portion and a second thickness at the lower tapering region of the conical lower portion; and
the second thickness is less than the first thickness.
